(19) United States
(12) Patent Application Publication
(10) Pub. No.: US 2023/0376515 A1
(43) Pub. Date: Nov. 23, 2023

(54) GENERATING SUMMARY DOCUMENTS FOR COMMUNICATIONS IN A COMMUNICATION PLATFORM

(71) Applicant: Slack Technologies, LLC, San Francisco, CA (US)

(72) Inventor: Sai Bhaskar Bharadwaj Tanikella, Vancouver (CA)

(21) Appl. No.: 17/747,576

(22) Filed: May 18, 2022

(51) Int. Cl. G06F 16/34; G06F 40/205; H04L 51/214

(52) U.S. Cl. CPC G06F 16/345; G06F 40/205; H04L 51/214

(57) ABSTRACT

Techniques for generating summary documents from conversations within a communication platform are described herein. For example, a user can communicate within or generate a virtual space, which can include a means for transmitting written communications (e.g., communication channel, direct message instance, etc.), documents (e.g., videos, images, pdfs, etc.), and/or oral communications (e.g., audio call, video call, etc.) among the users. In some examples, a machine-learned summarization model can receive some or all of the contents of a virtual space and can generate a summarization document reflecting the contents of various communications. The summarization document can include permissions associated with such a virtual space and/or can be edited or shared with other users of the communication platform. As such, the communication platform can enable users to create a document for summarizing content and events that transpired within the virtual space.

### TECHNICAL FIELD

Communication platforms are becoming increasingly popular for facilitating work-related communications, such as for project collaboration within a single organization and across two or more organizations. To facilitate project collaboration, users often share information or engage in discussions within the communication platforms. However, reviewing conversations within communication platforms requires large amounts of time to extract important parts of the conversation. Existing systems may allow a user to search through the conversation based on key terms, search functions, and the like to access relevant portions of the conversation. In these existing chat systems, however, even if a user is able to access or search through conversations, information presented to the user is often scattered, disorganized, and unpresentable. As such, the user still needs to spend significant time and effort to manually review a large amount of conversations.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIG. 2 illustrates an example user interface associated with a summary document.

FIGS. 3A-3D illustrate example user interfaces for requesting and generating a summary document, as described herein.

FIGS. 4A and 4B illustrate example user interfaces for requesting and generating a summary document, as described herein.

FIG. 5 is an example process for requesting and generating a summary document, as described herein.

FIG. 6 is an example process for requesting and generating a summary document, as described herein.

### DETAILED DESCRIPTION

Techniques for generating summary documents from conversations within a communication platform are described herein. The communication platform can be a group-based communication platform, a channel-based messaging platform, and/or any other platform for facilitating communication between and among users. For example, a user can communicate within or generate a virtual space to discuss a particular project, incident, and so forth. The virtual space can include a means for transmitting written communications (e.g., communication channel, direct message instance, etc.), documents (e.g., videos, images, pdfs, etc.), and/or oral communications (e.g., audio call, video call, etc.) among the users. In some examples, the summary documents are created within the communication platform. For example, within the communication platform, a contextual conversation may take place between two or more users and the communication platform may generate the summary document associated with the conversation. More particularly, when users are communicating within virtual space, the communication platform may track the natural language of the user for use in generating the summary document. In some examples, the communication platform may identify the users within the virtual space, actions associated with the users, and other contributions to the conversation to generate the summary document. As such, the communication platform can enable users to create a document for summarizing content and events that transpired within the virtual space.

In an example, the communication platform can receive a request from a user to create a summary document. In some examples, the request may be received via a virtual space (e.g., workspace, communication channel, direct message instance, document, board, audio or video communication, etc.) associated with the communication platform. For example, during, after, or in between conversations in the virtual space, the user may request generation of the summary document. In some examples, the request to generate the summary document may be received in order to bring a user up-to-speed as to the conversations within the virtual space. For example, the user may have been absent (e.g., sick, vacation, etc.) and unable to keep track of the communications within the virtual space. Upon returning, the user may request the summary document.

In other examples, following a conclusion of a virtual space or a particular matter, subject, or incident being discussed within the virtual space, the user may wish to generate a summary of the virtual space. For example, in response to an incident (e.g., a bug experienced by a user), a virtual space may be created to resolve the incident. Within the virtual space, users may collaborate with one another to resolve the incident. This may involve the users posting messages to the virtual space, posting content (e.g., audio, video, links, etc.) to the virtual space, and so forth. Upon resolution of the incident, or throughout the course of resolving the incident, one of the users of the virtual space may request generation of the summary document, which in this instance, may represent a root cause analysis (RCA) document that summarizes the incident, determined results, problems, solutions, and so forth. In this manner, generating the summary document that summarizes the discussion among users may be reviewed in a more efficient manner as compared to reviewing an entirety of the virtual space to understand the incident and the root cause.

In some examples, the communication platform may identify one or more users (e.g., members, collaborators, etc.) of the virtual space as user(s) to be associated with the summary document. User identifier(s) that are associated with the virtual space, for example, may be associated with the summary document such that the users of the virtual space are identified within the summary document. This allows for the summary document to identify the communications of each user and how each user interacted within the virtual space. For example, the summary document may include identifier(s) of the users to indicate their contributions of each user and how they interacted within the virtual space.

In some examples, the user may request the summary document for an entirety of the virtual space (e.g., all communications within the virtual space), or may define criteria associated with the summary document. For example, the user may request that the summary document include a summary of the virtual space between certain periods of time (e.g., start date/time, ending date/time), between certain users within the virtual space (e.g., a first user and a second user), for certain files (e.g., video, audio, picture, document, etc.) posted within the virtual space, and so forth. For example, the user may request that the summary document only summarize the virtual space on a particular day, as compared to summarizing an entirety of the communications within the virtual space. In other examples, the summary document may be created automatically following a lapse of a certain time period (e.g., every week, every day, every month, etc.), based on certain events (e.g., return from office after a vacation), after a threshold number of messages being posted to the communication channel, and so forth.

In some examples, the summary document may be generated based on any number of virtual spaces. For example, the conversations from a first virtual space may be summarized with conversations in a second virtual space. These conversations may be from similar or like incidents and summarizing the findings (e.g., RCA) from the similar incidents may produce a single summary document. However, in some examples, a user may, as a single request, request generation of a summary document for multiple virtual spaces and in turn, a single or respective summary documents may be generated. For a single document, the summary document may indicate from which virtual spaces the summary document was generated.

In some examples, to request the summary document, the user may select an affordance (e.g., icon, link, text, image, etc.). In some examples, the affordance may be presented within the virtual space, for example, on part of a user interface presented to the user. Based on the selection of the affordance, the communication platform may receive the request to create the summary document. In an example, the user can request to create a summary document and the request may include an indication (e.g., virtual space ID) of the virtual space with which to associate the summary document. For example, the user may identify the virtual space with which to create the summary document. Noted above, the request may include indications of multiple virtual spaces in which to individually or collectively summarize. Alternatively, in some examples, the request may be received independent of a virtual space. In some examples, the request may be invoked via an API and specifying a channel summarization, a certain command posted to the communication channel (e.g., @summarization, @summary, etc.). The request may also specify or include additional context data, user names, permissions, time periods, topics, and so forth.

In response to receiving the request, the communication platform may include trained machine-learned (ML) model(s) that accepts inputs, and using the inputs, outputs the summary document. In some examples, the inputs may be conversation data from a virtual space that includes text messages, emojis, user identifiers, user actions (e.g., “likes” or “dislikes”), charts, videos, and/or other forms of content. However, the inputs may also include text data, documents, images, video(s), or other forms of content with which to summarize. For example, continuing with the example above in which the virtual space is created to resolve an incident, the inputs may include ticket data associated with the incident (e.g., as submitted from a user), communications that took place within the virtual space between users to resolve the incident (e.g., virtual space text communications), and/or users involved in the communications within the virtual space. Other information, however, may be included when requesting the generation of the summary document.

The ML model(s) may be trained to identify one or more users to be associated with the summary document, such as those users that were mentioned in the virtual space, posted to the virtual space, or are members of the virtual space. In some examples, the ML model(s) may include a Generative Pre-trained Transformer 3 (GPT-3) model, a neural model for summarization, such as an abstractive or a generative summarization model, a machine-learned summarization model, natural language processing, machine learning, and/or other techniques that identify meaning and/or sentiment in messages within the virtual space. In such examples, these techniques are configured to receive various forms of inputs for generating the summary document.

The ML model(s) may also be configured to recognize certain users within the virtual space and apply a certain weight to their communications. For example, users within the virtual space may have certain roles (e.g., CEO, CTO, etc.) and their communications may be given a greater weight as compared to other users. In some examples, the ML model(s) identify or receive an input as to the weight to be applied to the communications of these individuals, and their communications may be given precedent when generating the summary document. However, the ML model(s) may additionally, or alternatively, give precedent to the communications of certain users based on a recency of communications by the user, a frequency of communications by the user, communications (or other interactions of the users) exceeding a threshold level, communications of the user being marked as a favorite, an assignment of tasks to users, a rating of the users, an expertise of the user, user preferences implied on their respective roles, user specified parameters, user specified permissions, heuristics from user activities, and/or other interactions of the users with previously generated summary documents.

In some examples, the summary document may identify tasks that are assigned to and/or are to be carried out by certain users. For example, the ML model(s) may determine the tasks from the communications that took place within the virtual space. Here, the summary document may include a list of tasks or action items that the users are to perform and/or which the users have performed as part of resolving the incident. These tasks, in some examples, may be ranked as an order list by matter of importance, timing, department, and so forth. In some examples, the tasks may be associated with a particular user that will perform the task, a certain period of time in which the user is expected to perform the task, a purpose associated with completing the task, and so forth.

The summary document may include text that summarizes content, communications, and so forth within the virtual space. In some examples, the summary document may include textual formats. The text may be organized into bullet-point format, paragraph format, table format, and the like. For example, the text may identify the contributed users and what users contributed to the conversations within the virtual space. Still, in some examples, the summary document may summarize the virtual space at various levels of details, such as an executive summary (e.g., one page summary), an abstract (e.g., five to six sentence summary), and the like. In some examples, the user requesting the summary document may specify which format of the summary is to be included in the summary document.

The summary document may also identify action(s), upload(s), conversation(s), and the like that transpired in the virtual space. For example, the summary document may include message timing documentation (e.g., time stamps) associated with messages between the user, audio and/or video communications, file uploads, notifications, new messages posted, mentions or tags, mentioning or tagging functionalities, event conveyance, workflow management and tracking, access permissions, and/or other functionalities that occurred within the virtual space or which are enabled based on the type of virtual space.

Additionally, or alternatively, the summary document may include various visualizations, such as but not limited to, a cluster of profile photo of icons representing engagements of users in the conversation, a cluster of emojis used in the conversations representing the sentiments of the conversation, a compilation of visual elements in a tree structure representing the intensity and evolution of user reactions and engagements in the conversation, and/or the like.

In some examples, the summary document can support editable text and/or objects that can be ordered, added, deleted, modified and/or the like. An object can include, but is not limited to, text (e.g., which can be editable), a file (e.g., text, audio, video, an application, etc.), a task to be completed, a ticket to be resolved, an event (e.g., scheduled event, calendar invitation, calendar instance, etc.), a message previously transmitted via the communication platform, an image, a graphic, a link to a local object, a link to a remote object (e.g., third-party object), and/or the like. In this manner, the communication platform can treat the summary document as a synopsis or outline of the virtual space and the posts, events, etc. that took place within the virtual space. As such, functionalities of the virtual space may be imbued in the summary document.

The communication platform may configure the summary document to be shared with one or more additional users. For example, after generating the summary document, the user may share the summary document with other user(s) in the virtual space or on the communication platform. In some examples, the summary document may be shared by an administrator or owner of the summary document, such as the user who requested the summary document. That is, the user associated with a creation of the summary document may include permissions to share the summary document with additional users of the virtual space. In some examples, the summary document can be configured to be shared based on permission setting(s) associated therewith. In another example, the summary document may be configured such that all users of the virtual space are able to view the summary document.

As part of the user sharing the summary document, the communication platform can cause an indication (e.g., visualization) of the summary document to be presented in a sidebar of a user interface associated with the user(s), respectively. For example, the user(s) can select an affordance to access the summary document. Upon generation of the summary document, the communication platform may cause display of the affordance (e.g., identifier, indicator, selectable control, user interface element, etc.) associated with the summary document in association with the virtual space. In some examples, the affordance may enable users of the virtual space to access, modify, communicate, and/or collaborate with the summary document. In some examples, the sidebar of the virtual space includes lists of virtual spaces that are associated with a particular user account. For example, the sidebar may include a list of documents, workspaces, communication channels, direct messaging instances, and/or the like that are associated with a user account of a viewing user. Upon selection of the affordance, the communication platform causes the summary document to be presented via the user interface. Still, in other examples, the summary document may be posted automatically in the communication channel, opened automatically in another pane, opened as a separate document, posted in another communication channel, and/or may notify users that summary document has been created.

However, in various examples, the communication platform can receive a request to share the summary document with one or more additional users of the communication platform. In examples in which the summary document is generated in association with a virtual space, the request can represent a request to share the collaborative document with additional user(s) who are not associated with the virtual space (e.g., a channel, a synchronous meeting, a current document). In examples in which the summary document is generated independent of a virtual space (e.g., generated in association with the user account of the first user), the request can represent a request to share the summary document with one or more other users of the communication platform. In this example, the request can include one or more user identifiers associated with the additional user(s). In such examples, the collaborative document can be shared with the additional user(s) directly, such as via a direct messaging instance or via a mention to a reference of an additional user's account. In some examples, the request can include one or more virtual space identifiers associated with the communication platform. In such examples, the collaborative document can be shared via the identified virtual space(s).

In some examples, after generation of the summary document but before sharing the summary document, the user may be permitted to edit or otherwise modify the summary document. For example, the user who requested the summary document may reorganize content within the summary document (e.g., textual, visual, etc.), correct informalities within the summary document (e.g., spelling, punctuation, format, etc.), add content (e.g., textual, visual, etc.) within the summary document, delete content within the summary document, and so forth. In some examples, these changes may be tracked within the summary document such that additional users are able to see the changes made by the user. Other users, however, may additionally or alternatively have the option to similarly edit the summary document before the summary document is made available or otherwise shared with the virtual space.

In some examples, the summary document may be editable or read only. In some examples, the user can include a permission setting associated with editing functionality of the summary document. That is, the user requesting that the summary document be shared with the additional user(s) can establish permission settings associated with the additional user(s). The permission settings can include a read or view-only setting, full editing permissions, and/or the like. In various examples, the communication platform may store the permission settings associated with the additional user(s) in association with the summary document. In some examples, permission settings can be on a section by section within the summary document basis where a user may modify a first section of a collaborative document, but not a second section of the collaborative document.

In some examples, the summary document may be updated in instances where additional communications occur with the virtual space. For example, after the summary document is generated, users may continue to communicate within the virtual space. In some examples, the users may request that the summary document is updated to reflect the additional communications within the virtual space. Here, the new updated summary document may indicate changes between the initial summary document and the updated summary. In some examples, the updated summary document may replace the initial summary document such that a most-recent summary document is available to the users. In some examples, the summary document may be updated by the users of the virtual space editing the summary document. In this instance, the users may not request generation of a new summary document, but may instead update the previously generated summary document. Hereto, changes made by the users to the summary document may be tracked and recorded.

Although discussed herein as being created in association with the virtual space, in some examples, the summary document may be created independent of a virtual space. For example, the communication platform may identify the requesting user as a user to be associated with the summary document. In such examples, the communication platform can associate an identifier with the requesting user for the summary document, where the identifier can include a real name, username, combination of one or more numbers, letters, symbols, and/or the like.

The techniques described herein may greatly enhance the utility and functionality of a summary document within the communication platform. For example, in conventional techniques, summaries of the virtual space might not be easily digestible and users may spend countless time searching through virtual spaces and the content contained therein to get caught up to speed about a particular matter, conversation, and the like. In these instances, users may be misinformed, for example, as a result of misreading communications or reading outdated communications within the virtual space. This may lead to inconsistent actions taking place, redundant actions being performed by the users, and so forth. As such, the use of the summary document may keep users informed, which may lead to increased productivity and improved user experiences.

Additionally, the summary document may be shared amongst users within the communication channel, which reduces users having to individually or collectively send the summary document to additional users. This reduces the amount of versions of the summary document that are generated and stored, and/or the amount of other applications or platforms required to share the summary document, which saves a significant amount of computing resources, processing, and storage. The generation of the summary document further reduces the amount of computing resource(s) that would otherwise be required by the users to view or scroll through the virtual spaces. Additionally, as the summary document is posted or otherwise shared to the virtual space, network bandwidth is saved by lessening the amount of communication between users.

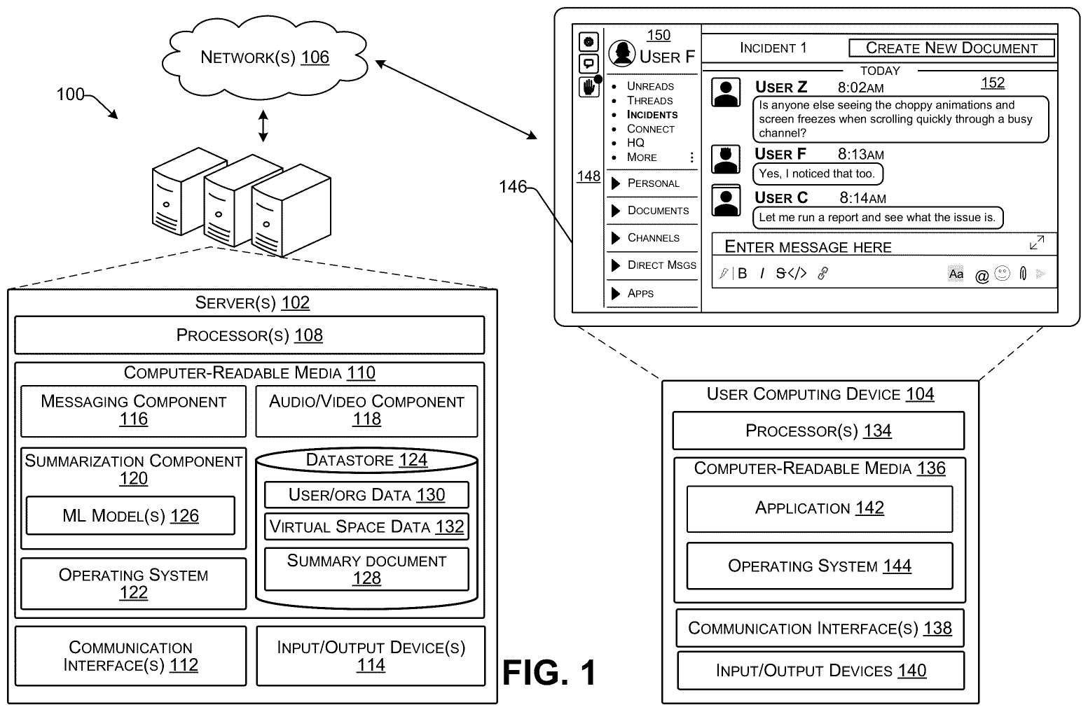

Additional details and examples are described below with reference to FIGS. 1-6.

FIG. 1 illustrates an example environment 100 for performing techniques described herein. In at least one example, the environment 100 can be associated with a communication platform that can leverage a network-based computing system to enable users of the communication platform to exchange data. In at least one example, the communication platform can be “group-based” such that the platform, and associated systems, communication channels, messages, collaborative documents, canvases, audio/video conversations, and/or other virtual spaces, have security (that can be defined by permissions) to limit access to a defined group of users. In some examples, such groups of users can be defined by group identifiers, as described above, which can be associated with common access credentials, domains, or the like. In some examples, the communication platform can be a hub, offering a secure and private virtual space to enable users to chat, meet, call, collaborate, transfer files or other data, or otherwise communicate between or among each other. As described above, each group can be associated with a workspace, enabling users associated with the group to chat, meet, call, collaborate, transfer files or other data, or otherwise communicate between or among each other in a secure and private virtual space. In some examples, members of a group, and thus workspace, can be associated with a same organization. In some examples, members of a group, and thus workspace, can be associated with different organizations (e.g., entities with different organization identifiers).

In at least one example, the environment 100 can include one or more server computing devices (or “server(s)”) 102. In at least one example, the server(s) 102 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device (e.g., portable, semi-portable, semi-stationary, or stationary). Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example environment 100 can include multiple (e.g., tens of, hundreds of, thousands of, millions of) user computing devices. In at least one example, user computing devices, such as the user computing device 104, can be operable by users to, among other things, access communication services via the communication platform. A user can be an individual, a group of individuals, an employer, an enterprise, an organization, and/or the like.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

In at least one example, the server(s) 102 can include one or more processor(s) 108, computer-readable media 110, one or more communication interface(s) 112, and input/output devices 114.

In at least one example, each processor of the processor(s) 108 can be a single processing unit or multiple processing units, and can include single or multiple computing units or multiple processing cores. The processor(s) 108 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 108 can be one or more hardware processors and/or logic circuits of any suitable type specifically programmed or configured to execute the algorithms and processes described herein. The processor(s) 108 can be configured to fetch and execute computer-readable instructions stored in the computer-readable media, which can program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 110 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 108. In many implementations, these functional components comprise instructions or programs that are executable by the processor(s) 108 and that, when executed, specifically configure the processor(s) 108 to perform the actions attributed above to the server(s) 102. Functional components stored in the computer-readable media can optionally include a messaging component 116, an audio/video component 118, a summarization component 120, an operating system 122, and a datastore 124.

In at least one example, the messaging component 116 can process messages between users. That is, in at least one example, the messaging component 116 can receive an outgoing message from a user computing device 104 and can send the message as an incoming message to a second user computing device 104. The messages can include direct messages sent from an originating user to one or more specified users and/or communication channel messages sent via a communication channel from the originating user to the one or more users associated with the communication channel. In some examples, data can be associated with a channel via a channel indicator. Additionally, in some examples, the messages can be transmitted in association with a collaborative document, canvas, or other collaborative space. In at least one example, the canvas can include a flexible canvas for curating, organizing, and sharing collections of information between users. In at least one example, the collaborative document can be associated with a document identifier (e.g., virtual space identifier, communication channel identifier, channel indicator, etc.) configured to enable messaging functionalities attributable to a virtual space (e.g., a communication channel) within the collaborative document. That is, the collaborative document can be treated as, and include the functionalities associated with, a virtual space, such as a communication channel. The virtual space, or communication channel, can be a data route used for exchanging data between and among systems and devices associated with the communication platform.

In at least one example, the messaging component 116 can establish a communication route between and among various user computing devices, allowing the user computing devices to communicate and share data between and among each other. In at least one example, the messaging component 116 can manage such communications and/or sharing of data. In some examples, data associated with a virtual space can be presented via a user interface. In addition, metadata associated with each message transmitted via the virtual space, such as a time stamp associated with the message, a sending user identifier, a recipient user identifier, a conversation identifier and/or a root object identifier (e.g., conversation associated with a thread and/or a root object), and/or the like, can be stored in association with the virtual space.

In various examples, the messaging component 116 can receive a message transmitted in association with a virtual space (e.g., direct message instance, communication channel, canvas, collaborative document, etc.). In various examples, the messaging component 116 can identify one or more users associated with the virtual space and can cause a rendering of the message in association with instances of the virtual space on respective user computing devices 104. In various examples, the messaging component 116 can identify the message as an update to the virtual space and, based on the identified update, can cause a notification associated with the update to be presented in association with a sidebar of user interface associated with one or more of the user(s) associated with the virtual space. For example, the messaging component 116 can receive, from a first user account, a message transmitted in association with a virtual space. In response to receiving the message (e.g., interaction data associated with an interaction of a first user with the virtual space), the messaging component 116 can identify a second user associated with the virtual space (e.g., another user that is a member of the virtual space). In some examples, the messaging component 116 can cause a notification of an update to the virtual space to be presented via a sidebar of a user interface associated with a second user account of the second user. In some examples, the messaging component 116 can cause the notification to be presented in response to a determination that the sidebar of the user interface associated with the second user account includes an affordance associated with the virtual space. In such examples, the notification can be presented in association with the affordance associated with the virtual space.

In various examples, the messaging component 116 can be configured to identify a mention or tag associated with the message transmitted in association with the virtual space. In at least one example, the mention or tag can include an @mention (or other special character) of a user identifier that is associated with the communication platform. The user identifier can include a username, real name, or other unique identifier that is associated with a particular user. In response to identifying the mention or tag of the user identifier, the messaging component 116 can cause a notification to be presented on a user interface associated with the user identifier, such as in association with an affordance associated with the virtual space in a sidebar of a user interface associated with the particular user and/or in a virtual space associated with mentions and reactions. That is, the messaging component 116 can be configured to alert a particular user that they were mentioned in a virtual space.

In at least one example, the audio/video component 118 can be configured to manage audio and/or video communications between and among users. In some examples, the audio and/or video communications can be associated with an audio and/or video conversation. In at least one example, the audio and/or video conversation can include a discrete identifier configured to uniquely identify the audio and/or video conversation. In some examples, the audio/video component 118 can store user identifiers associated with user accounts of members of a particular audio and/or video conversation, such as to identify user(s) with appropriate permissions to access the particular audio and/or video conversation.

In some examples, communications associated with an audio and/or video conversation (“conversation”) can be synchronous and/or asynchronous. That is, the conversation can include a real-time audio and/or video conversation between a first user and a second user during a period of time and, after the first period of time, a third user who is associated with (e.g., is a member of) the conversation can contribute to the conversation. The audio/video component 118 can be configured to store audio and/or video data associated with the conversation, such as to enable users with appropriate permissions to listen and/or view the audio and/or video data.

In some examples, the audio/video component 118 can be configured to generate a transcript of the conversation, and can store the transcript in association with the audio and/or video data. The transcript can include a textual representation of the audio and/or video data. In at least one example, the audio/video component 118 can use known speech recognition techniques to generate the transcript. In some examples, the audio/video component 118 can generate the transcript concurrently or substantially concurrently with the conversation. That is, in some examples, the audio/video component 118 can be configured to generate a textual representation of the conversation while it is being conducted. In some examples, the audio/video component 118 can generate the transcript after receiving an indication that the conversation is complete. The indication that the conversation is complete can include an indication that a host or administrator associated therewith has stopped the conversation, that a threshold number of meeting attendees have closed associated interfaces, and/or the like. That is, the audio/video component 118 can identify a completion of the conversation and, based on the completion, can generate the transcript associated therewith.

In at least one example, the audio/video component 118 can be configured to cause presentation of the transcript in association with a virtual space with which the audio and/or video conversation is associated. For example, a first user can initiate an audio and/or video conversation in association with a communication channel. The audio/video component 118 can process audio and/or video data between attendees of the audio and/or video conversation, and can generate a transcript of the audio and/or video data. In response to generating the transcript, the audio/video component 118 can cause the transcript to be published or otherwise presented via the communication channel. In at least one example, the audio/video component 118 can render one or more sections of the transcript selectable for commenting, such as to enable members of the communication channel to comment on, or further contribute to, the conversation. In some examples, the audio/video component 118 can update the transcript based on the comments.

In at least one example, the audio/video component 118 can manage one or more audio and/or video conversations in association with a virtual space associated with a group (e.g., organization, team, etc.) administrative or command center. The group administrative or command center can be referred to herein as a virtual (and/or digital) headquarters associated with the group. In at least one example, the audio/video component 118 can be configured to coordinate with the messaging component 116 and/or other components of the server(s) 102, to transmit communications in association with other virtual spaces that are associated with the virtual headquarters. That is, the messaging component 116 can transmit data (e.g., messages, images, drawings, files, etc.) associated with one or more communication channels, direct messaging instances, collaborative documents, canvases, and/or the like, that are associated with the virtual headquarters. In some examples, the communication channel(s), direct messaging instance(s), collaborative document(s), canvas(es), and/or the like can have associated therewith one or more audio and/or video conversations managed by the audio/video component 118. That is, the audio and/or video conversations associated with the virtual headquarters can be further associated with, or independent of, one or more other virtual spaces of the virtual headquarters.

In at least one example, the summarization component 120 generates summary documents associated with the virtual space. The summarization component 120 may receive a request from the user, via the user computing device 104, associated with generating the summary document. In some examples, the request may be received via the virtual space (e.g., workspace, communication channel, direct message instance, document, board, audio or video communication, etc.) associated with the communication platform. In some examples, the user may request the summary document for an entirety of the virtual space (e.g., all communications within the virtual space), or may define criteria associated with the summary document. For example, the user may request that the summary document include a summary of the virtual space between certain periods of time (e.g., start date/time, ending date/time), between certain users within the virtual space (e.g., a first user and a second user), and so forth.

The summarization component 120 may utilize machine-learned (ML) model(s) 126 that accepts inputs, and using the inputs, outputs a summary document 128 that is stored in the datastore 124. In some examples, the inputs may be conversation data from the virtual space that includes text messages, emojis, user identifiers, user actions (e.g., “likes” or “dislikes”), charts, videos, and/or other forms of content. However, the inputs may also include text data, documents, images, video(s), transcripts of the audio/video, or other forms of content that the summarization component 120 is to summarize. For example, the summarization component 120 may be tasked with summarizing an incident and generating the summary document 128 that represents a RCA of the incident. In this example, the virtual space may be created to resolve the incident, and within the virtual space, users may collaborate with one another to resolve the incident. This may involve the users posting messages to the virtual space, posting content (e.g., audio, video, links, etc.) to the virtual space, and so forth. Here, the inputs to the ML model(s) 126 may include ticket data associated with the incident (e.g., as submitted from a user), communications that took place within the virtual space between other users to resolve the incident (e.g., virtual space text communications), and/or users involved in the communications within the virtual space. Other information, however, may be included when requesting the generation of the summary document 128.

The ML model(s) 126 may be trained to summarize the communications within the virtual space. For example, the ML model(s) 126 may distill important parts of a conversation within the virtual space based on contextual cues, a frequency of communications by the user(s), past feedback, communications (or other interactions of the users) exceeding a threshold level, communications of the user being marked as a favorite, an assignment of tasks to users, a rating of the users, an expertise of the user, user preferences implied on their respective roles, user specified parameters, user specified permissions, heuristics from user activities, and/or other interactions of the users with previously generated summary documents. Additionally, the ML model(s) 126 may be trained to identify one or more users to be associated with the summary document 128, such as those users that were mentioned in the virtual space, posted to the virtual space, or are members of the virtual space. The ML model(s) 126 may also be trained to identify the respective messages, contributions, posts, and the like for the user(s) within the virtual space.

In some examples, the ML model(s) 126 may be trained from training data that represents previous summary documents generated using supervised and/or unsupervised approaches. In some examples, the ML model(s) may include a Generative Pre-trained Transformer 3 (GPT-3) model, a neural model for summarization, such as an abstractive or a generative summarization model, natural language processing, machine learning, and/or other techniques that identify meaning and/or sentiment in messages within the virtual space. In such instances, these techniques are configured to receive various forms of inputs for generating the summary document.

The summary document 128 may include text that summarizes content, communications, and so forth within the virtual space. The summary document 128 may also identify action(s), upload(s), conversation(s), and the like that transpired in the virtual space. In some examples, the summary document 128 may include textual formats. The text may be organized into bullet-point format, paragraph format, table format, and the like. For example, the text may identify the contributed users and what users contributed to the conversations within the virtual space. Still, in some examples, the summary document 128 may summarize the virtual space at various levels of details, such as an executive summary (e.g., one page summary), an abstract (e.g., five to six sentence summary), and the like. Additionally, or alternatively, the summary document 128 may include various visualizations, such as but not limited to, a cluster of profile photo of icons representing engagements of users in the conversation, a cluster of emojis used in the conversations representing the sentiments of the conversation, a compilation of visual elements in a tree structure representing the intensity and evolution of user reactions and engagements in the conversation, and/or the like. In some examples, the user requesting the summary document 128 may specify which format of the summary is to be included in the summary document 128.

In some examples, the summary document 128 may support editable text and/or objects that can be ordered, added, deleted, modified and/or the like. An object can include, but is not limited to, text (e.g., which can be editable), a file (e.g., text, audio, video, an application, etc.), a task to be completed, a ticket to be resolved, an event (e.g., scheduled event, calendar invitation, calendar instance, etc.), a message previously transmitted via the communication platform, an image, a graphic, a link to a local object, a link to a remote object (e.g., third-party object), and/or the like.

The summary document 128 may be generated with certain permissions, and different users may have different permissions. For example, the summary document may be editable or read only. In some examples, the user requesting that the summary document be shared with the additional user(s) can establish permission settings associated with the additional user(s). The permission settings can include a read or view-only setting, full editing permissions, and/or the like.

In some examples, after generation of the summary document 128 but before sharing the summary document 128, the user may be permitted to edit or otherwise modify the summary document 128. For example, the user who requested the summary document 128 may reorganize content within the summary document 128 (e.g., textual, visual, etc.), correct informalities within the summary document 128 (e.g., spelling, punctuation, format, etc.), add content (e.g., textual, visual, etc.) to the summary document 128, delete content within the summary document 128, and so forth. In some examples, these changes may be tracked within the summary document 128 such that additional users are able to see the changes made by the user. Other users, however, may additionally or alternatively have the option to similarly edit the summary document 128 before the summary document 128 is made available or otherwise shared with the virtual space.

In some examples, the summary document 128 may be updated in instances where additional communications occur with the virtual space. For example, after the summary document 128 is generated, users may continue to communicate within the virtual space. In some examples, the users may request that the summary document 128 is updated to reflect the additional communications within the virtual space. Here, the new updated summary document 128 may indicate changes between the initial summary document 128. In some examples, the updated summary document may replace the initial summary document 128 such a most-recent summary document is available to the users. In some examples, the summary document 128 may be updated by the users of the virtual space editing the summary document 128. In this instance, the users may not request generation of a new summary document 128, but may instead update the previously generated summary document 128. Hereto, changes made by the users to the summary document 128 may be tracked and recorded.

Additional details of operations that can be performed by the summarization component 120 are described below.

In at least one example, the operating system 122 can manage the processor(s) 108, computer-readable media 110, hardware, software, etc. of the server(s) 102.

In at least one example, the datastore 124 can be configured to store data that is accessible, manageable, and updatable. In some examples, the datastore 124 can be integrated with the server(s) 102, as shown in FIG. 1. In other examples, the datastore 124 can be located remotely from the server(s) 102 and can be accessible to the server(s) 102 and/or user device(s), such as the user computing device 104. The datastore 124 can comprise multiple databases, which can include the summary document 128, user/org data 130, and/or virtual space data 132. Additional or alternative data may be stored in the data store and/or one or more other data stores.

In at least one example, the user/org data 130 can include data associated with users of the communication platform. In at least one example, the user/org data 130 can store data in user profiles (which can also be referred to as “user accounts”), which can store data associated with a user, including, but not limited to, one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In at least one example, the user/org data 130 can include permission data associated with permissions of individual users of the communication platform. In some examples, permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. Permissions associated with an individual user can be mapped to, or otherwise associated with, an account or profile within the user/org data 130. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In at least one example, the user/org data 130 can include data associated with one or more organizations of the communication platform. In at least one example, the user/org data 130 can store data in organization profiles, which can store data associated with an organization, including, but not limited to, one or more user identifiers associated with the organization, one or more virtual space identifiers associated with the organization (e.g., workspace identifiers, communication channel identifiers, direct message instance identifiers, collaborative document identifiers, canvas identifiers, audio/video conversation identifiers, etc.), an organization identifier associated with the organization, one or more organization identifiers associated with other organizations that are authorized for communication with the organization, and the like.

In at least one example, the virtual space data 132 can include data associated with one or more virtual spaces associated with the communication platform. The virtual space data 132 can include textual data, audio data, video data, images, files, and/or any other type of data configured to be transmitted in association with a virtual space. Non-limiting examples of virtual spaces include workspaces, communication channels, direct messaging instances, collaborative documents, canvases, and audio and/or video conversations. In at least one example, the virtual space data can store data associated with individual virtual spaces separately, such as based on a discrete identifier associated with each virtual space. In some examples, a first virtual space can be associated with a second virtual space. In such examples, first virtual space data associated with the first virtual space can be stored in association with the second virtual space. For example, data associated with a collaborative document that is generated in association with a communication channel may be stored in association with the communication channel. For another example, data associated with an audio and/or video conversation that is conducted in association with a communication channel can be stored in association with the communication channel.

As discussed above, each virtual space of the communication platform can be assigned a discrete identifier that uniquely identifies the virtual space. In some examples, the virtual space identifier associated with the virtual space can include a physical address in the virtual space data 132 where data related to that virtual space is stored. A virtual space may be “public,” which may allow any user within an organization (e.g., associated with an organization identifier) to join and participate in the data sharing through the virtual space, or a virtual space may be “private,” which may restrict data communications in the virtual space to certain users or users having appropriate permissions to view. In some examples, a virtual space may be “shared,” which may allow users associated with different organizations (e.g., entities associated with different organization identifiers) to join and participate in the data sharing through the virtual space. Shared virtual spaces (e.g., shared channels) may be public such that they are accessible to any user of either organization, or they may be private such that they are restricted to access by certain users (e.g., users with appropriate permissions) of both organizations. In some examples, levels of accessibility of a document or virtual space may be referred to as publicity.

In some examples, the datastore 124 can be partitioned into discrete items of data that may be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database stored within the datastore 124 that stores data related to a particular organization identification. For example, a database shard may store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared virtual space).

In some examples, individual groups can be associated with a database shard within the datastore 124 that stores data related to a particular group identification (e.g., workspace). For example, a database shard may store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a virtual space can be associated with a database shard within the datastore 124 that stores data related to a particular virtual space identification. For example, a database shard may store electronic communication data associated with the virtual space, which enables members of that particular virtual space to communicate and exchange data with other members of the same virtual space in real time or near-real time. As discussed above, the communications via the virtual space can be synchronous and/or asynchronous. In at least one example, a group or organization can be the owner of the database shard and can control where and how the related data is stored.

In some examples, individual users can be associated with a database shard within the datastore 124 that stores data related to a particular user account. For example, a database shard may store electronic communication data associated with an individual user, which enables the user to communicate and exchange data with other users of the communication platform in real time or near-real time. In some examples, the user itself can be the owner of the database shard and has control over where and how the related data is stored.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via Websockets, Application Programming Interfaces (APIs) (e.g., using API calls), HyperText Transfer Protocols (HTTPs), etc.

The server(s) 102 can further be equipped with the input/output devices 114 (e.g., I/O devices). The input/output devices 114 can include a display, various user interface controls (e.g., buttons, joystick, keyboard, mouse, touch screen, etc.), audio speakers, connection ports and so forth.

In at least one example, the user computing device 104 can include one or more processor(s) 134, computer-readable media 136, one or more communication interface(s) 138, and input/output devices 140.

In at least one example, each processor of the processor(s) 134 can be a single processing unit or multiple processing units, and can include single or multiple computing units or multiple processing cores. The processor(s) 134 can comprise any of the types of processors described above with reference to the processor(s) 108 and may be the same as or different than the processor(s) 108.

The computer-readable media 136 can comprise any of the types of computer-readable media 136 described above with reference to the computer-readable media 110 and may be the same as or different than the computer-readable media 110. Functional components stored in the computer-readable media can optionally include at least one application 142 and an operating system 144.

In at least one example, the application 142 can be a mobile application, a web application, or a desktop application, which can be provided by the communication platform or which can be an otherwise dedicated application. In some examples, individual user computing devices associated with the environment 100 can have an instance or versioned instance of the application 142, which can be downloaded from an application store, accessible via the Internet, or otherwise executable by the processor(s) 134 to perform operations as described herein. That is, the application 142 can be an access point, enabling the user computing device 104 to interact with the server(s) 102 to access and/or use communication services available via the communication platform. In at least one example, the application 142 can facilitate the exchange of data between and among various other user computing devices, for example via the server(s) 102. In at least one example, the application 142 can present user interfaces, as described herein. In at least one example, a user can interact with the user interfaces via touch input, keyboard input, mouse input, spoken input, or any other type of input.

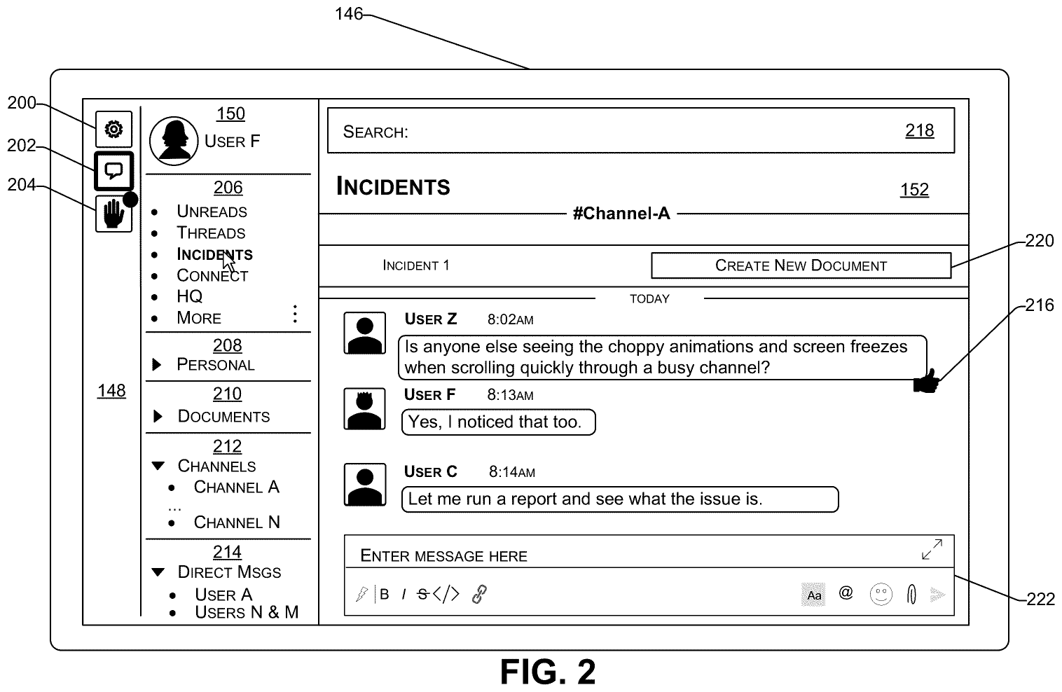

A non-limiting example of a user interface 146 is shown in FIG. 1. As illustrated in FIG. 1, the user interface 146 can present data associated with incidents in which the user is engaged or assisting. The user interface 146 allows the user to communicate with other users associated with the incidents. In some examples, the user interface 146 can include a first region 148, or pane, that includes indicator(s) (e.g., user interface element(s) or object(s)) associated with workspace(s) with which the user (e.g., account of the user) is associated. In some examples, the user interface 146 can include a second region 150, or pane, that includes indicator(s) (e.g., user interface element(s), affordance(s), object(s), etc.) representing data associated with the workspace(s) with which the user (e.g., account of the user) is associated. In at least one example, the second region 150 can represent a sidebar of the user interface 146. Additional details associated with the second region 150 and indicator(s) are described below with reference to FIG. 2.

In at least one example, the user interface 146 can include a third region 152, or pane, that can be associated with a data feed (or, “feed”) indicating messages posted to and/or actions taken with respect to one or more communication channels and/or other virtual spaces for facilitating communications (e.g., a virtual space associated with direct message communication(s), a virtual space associated with event(s) and/or action(s), etc.) as described herein. In at least one example, data associated with the third region 152 can be associated with the same workspaces. However, in some examples, the third region 152 can present data associated with the same or different workspaces via an integrated feed. In some examples, the data can be organized and/or is sortable by time (e.g., when associated data is posted or an associated operation is otherwise performed), type of action, communication channel, user, or the like. In some examples, such data can be associated with an indication of which user (e.g., member of the communication channel) posted the message and/or performed an action. In examples where the third region 152 presents data associated with multiple workspaces, at least some data can be associated with an indication of which workspace the data is associated with. Additional details associated with the user interface 146, and the third region 152, are described below with reference to FIG. 2.

In at least one example, the operating system 144 can manage the processor(s) 134, computer-readable media 136, hardware, software, etc. of the server(s) 102.

The communication interface(s) 138 can include one or more interfaces and hardware components for enabling communication with various other devices (e.g., the user computing device 104), such as over the network(s) 106 or directly. In some examples, the communication interface(s) 138 can facilitate communication via Websockets, APIs (e.g., using API calls), HTTPs, etc.

The user computing device 104 can further be equipped with various input/output devices 140 (e.g., I/O devices). The input/output devices 140 can include a display, various user interface controls (e.g., buttons, joystick, keyboard, mouse, touch screen, etc.), audio speakers, connection ports and so forth.

While techniques described herein are described as being performed by the messaging component 116, the audio/video component 118, the summarization component 120, and the application 142, techniques described herein can be performed by any other component, or combination of components, which can be associated with the server(s) 102, the user computing device 104, or a combination thereof

FIG. 2 illustrates additional details associated with the user interface 146 that presents data associated with virtual spaces created for incidents, as described above with reference to FIG. 1.

As described above, in at least one example, the user interface 146 can include a first region 148, or pane, that includes indicator(s) (e.g., user interface element(s) or object(s)) of workspace(s) with which the user (e.g., account of the user) is associated. In some examples, the workspaces can be associated with a same organization (e.g., associated with a same organization identifier). In some examples, one or more of the workspaces can be associated with different organizations (e.g., associated with different organization identifiers). In some examples, one of the workspaces can be associated with users from a single organization (e.g., associated with a same organization identifier) and another of the workspaces can be associated with users from two or more different organizations (e.g., associated with different organization identifiers).

In at least one example, each workspace can be associated with a different indicator 200-204, presented via the first region 148. In at least one example, a user account of the user (e.g., User F) can be associated with group identifiers that correspond to each of the workspaces (e.g., as determined by the user/org data 130 and/or the virtual space data 132). As such, the user account of the user can be associated with each of the workspaces. A first indicator 200 can represent a first workspace, a second indicator 202 can represent a second workspace, and a third indicator 204 can represent a third workspace.

In some examples, the user can navigate between the workspaces by actuating a control associated with each of the indicators 200-204 without needing to log out of one workspace and log in to each of the other workspaces. Non-limiting examples of such indicators, or any indictors described herein, can include icons, symbols, links, tabs, or other user interface elements or objects. In some examples, such indicators can be associated with actuation mechanisms to enable a user to select an indicator and transition to another workspace. In some examples, a visual indicator can indicate which workspace a user is currently interacting with and/or most recently interacted with. For example, the second indicator 202 is outlined in a heavier weight than the first indicator 200 and the third indicator 204, thereby indicating which workspace the user is currently interacting with and/or most recently interacted with. In some examples, the indicators 200-204 can be associated with another indicator indicating that the corresponding workspace has been updated. An example is shown with respect to the third indicator 204.

While three indicators 200-204 are illustrated in FIG. 2, the user can be associated with any number of workspaces. In some examples, indicators associated with all of the workspaces with which a user is associated can be presented via the first region 148. In some examples, some of the indicators associated with all of the workspaces with which a user is associated can be presented via the first region 148 and the user can interact with the user interface 146 to view additional or alternative indicators. In examples where fewer than all workspaces are represented via the user interface 146, the indicators can be arranged in alphabetical order, in an order of most recent interaction, in an order based on most frequent interaction, or some other order.

In some examples, the first region 148 may not be included in the user interface 146, and such information can be integrated into the user interface 146 via additional or alternative mechanisms.

In some examples, the user interface 146 can include a second region 150, or pane, that includes indicator(s) (e.g., user interface element(s) or object(s)) representing virtual space(s) associated with the workspace(s) with which the user (e.g., account of the user) is associated. In at least one example, the second region 150 can represent a sidebar of the user interface 146. In at least one example, the second region 150 can include one or more sub-sections, or sub-panes, which can represent different virtual spaces. For example, a first sub-section 206 can include indicators representing virtual spaces that can aggregate data associated with a plurality of virtual spaces of which the user is a member. In at least one example, each virtual space can be associated with an indicator in the first sub-section 206. In some examples, an indicator can be associated with an actuation mechanism (e.g., affordance) such that when actuated, can cause the application 142 to present data associated with the corresponding virtual space via the third region 152. In at least one example, a virtual space can be associated with all unread data associated with each of the workspaces with which the user is associated. That is, in some examples, if the user requests to access the virtual space associated with “unreads,” all data that has not been read (e.g., viewed) by the user can be presented in the third region 152, for example, in a feed. In such examples, different types of events and/or actions, which can be associated with different virtual spaces, can be presented via a same feed. In some examples, such data can be organized and/or is sortable by associated virtual space (e.g., virtual space via which the communication was transmitted), time, type of action, user, and/or the like. In some examples, such data can be associated with an indication of which user (e.g., member of the associated virtual space) posted the message and/or performed an action.

In some examples, a virtual space can be associated with a same type of event and/or action. For example, “threads” can be associated with messages, files, etc. posted in threads to messages posted in a virtual space and “incidents” can be associated with messages or threads where the user (e.g., User F) is engaged with other users to resolve an incident (e.g., bug, customer service/help, etc.). In some examples, the incidents may be organized by a ticket identification number (e.g., ticket ID), and the third region 152 may present information across multiple incidents. As with the “unreads” virtual space, data associated with such virtual spaces can be organized and/or is sortable by virtual space, time, type of action, user, and/or the like.

In some examples, a virtual space can be associated with facilitating communications between a user and other users of the communication platform. For example, “connect” can be associated with enabling the user to generate invitations to communicate with one or more other users. In at least one example, responsive to receiving an indication of selection of the “connect” indicator, the communication platform can cause a connections interface to be presented in the third region 152.

In some examples, a virtual space can be associated with a group (e.g., organization, team, etc.) headquarters (e.g., administrative or command center). In at least one example, the group headquarters can include a virtual or digital headquarters for administrative or command functions associated with a group of users. For example, “HQ” can be associated with an interface including a list of indicators associated with virtual spaces configured to enable associated members to communicate. In at least one example, the user can associate one or more virtual spaces with the “HQ” virtual space, such as via a drag and drop operation. That is, the user can determine relevant virtual space(s) to associate with the virtual or digital headquarters, such as to associate virtual space(s) that are important to the user therewith.

Though not illustrated, in some examples, a virtual space can include or be associated with summary documents. In at least one example, summary document(s) can include a document configured to be accessed and/or edited by two or more users with appropriate permissions (e.g., viewing permissions, editing permissions, etc.). In at least one example, if the user requests to access the virtual space associated with the summary document with which the user is associated, the one or more summary documents can be presented via the user interface 146 (e.g., in the third region 152). The summary document 128 may also be downloaded and/or a separate user interface may be presented to view the summary document 128. In at least one example, the summary document 128, as described herein, can be associated with an individual (e.g., private document for a user), a group of users (e.g., collaborative document), and/or one or more communication channels (e.g., members of the communication channel rendered access permissions to the document), such as to enable users of the communication platform to create, interact with, and/or view data associated with the summary documents 128. In some examples, the summary document 128 can be a virtual space, a board, a canvas, a page, or the like for collaborative communication and/or data organization within the communication platform. In at least one example, the summary document 128 can support editable text and/or objects that can be ordered, added, deleted, modified, and/or the like. In some examples, the summary document 128 can be associated with permissions defining which users of a communication platform can view and/or edit the document. In some examples, a summary document 128 can be associated with a communication channel, and members of the communication channel can view and/or edit the document. In some examples, a summary document 128 can be sharable such that data associated with the document is accessible to and/or interactable for members of the multiple communication channels, workspaces, organizations, and/or the like.

Additionally, though not illustrated, in some examples, a virtual space can be associated with one or more canvases with which the user is associated. In at least one example, the canvas can include a flexible canvas for curating, organizing, and sharing collections of information between users. That is, the canvas can be configured to be accessed and/or modified by two or more users with appropriate permissions. In at least one example, the canvas can be configured to enable sharing of text, images, videos, GIFs, drawings (e.g., user-generated drawing via a canvas interface), gaming content (e.g., users manipulating gaming controls synchronously or asynchronously), and/or the like. In at least one example, modifications to a canvas can include adding, deleting, and/or modifying previously shared (e.g., transmitted, presented) data. In some examples, content associated with a canvas can be sharable via another virtual space, such that data associated with the canvas is accessible to and/or rendered interactable for members of the virtual space.

In some examples, if the first sub-section 206 includes a user interface element representative of a virtual space associated with audio and/or video communications (e.g., conversations, multimedia clips (e.g., videos, audio files, stories, etc.), etc.) that is actuated by a user, audio and/or video data associated with the user, which can be associated with different audio and/or video conversations, multimedia clips, stories, and/or the like, can be presented via the third region 152. In some examples, such audio and/or video data can be presented via a feed. For the purpose of this discussion, audio and/or video data can correspond to audio and/or video content provided by a user associated with the communication platform.

In at least one example, the second region 150 of the user interface 146 can include a second sub-section 208, or sub-pane, that is a personalized sub-section associated with personal documents that are associated with the user account. In at least one example, the user can select personal documents to associate with the second sub-section 208, such as by dragging and dropping, pinning, or otherwise associating selected personal documents into the second sub-section 208.

In at least one example, the second region 150 of the user interface 146 can include a third sub-section 210, or sub-pane, or sub-pane, associated with summary documents 128 that are associated with the user account of the user. That is, a “documents” sub-section can include affordances associated with one or more summary documents 128 of which the user is a member. In various examples, the communication platform can determine one or more summary documents 128 to be associated with the documents sub-section (e.g., third sub-section 210) based on one or more ranking criteria. That is, the communication platform can cause affordances associated with highest ranking summary documents 128 of which the user is a member to be presented in the documents sub-section. In some examples, the user can pin or otherwise associate one or more summary documents 128 with the third sub-section 210. For example, the user can drag an affordance or other indicator associated with a summary documents 128 to the third sub-section 210 and release the selected summary documents 128 therein. In response to the drag-and-drop action, the communication platform can associate the selected summary documents 128 with the third sub-section 210 and cause presentation of an affordance of the selected summary documents 128 therein.

In at least one example, a label or other indicator associated with the third sub-section 210 can include an affordance that, when selected by the user, causes a documents interface to be presented in the third region 152 of the user interface 146. In some examples, the documents interface can include one or more lists of summary documents 128 with which the user account of the user is associated. For example, the documents interface can include a first list of personal summary documents 128 associated with the user account and a second list of summary documents 128 that include two or more members.

In at least one example, the second region 150 of the user interface 146 can include a fourth sub-section 212, or sub-pane, that includes indicators representing communication channels. In some examples, the communication channels can include public channels, private channels, shared channels (e.g., between groups or organizations), single workspace channels, cross-workspace channels, combinations of the foregoing, or the like. In some examples, the communication channels represented can be associated with a single workspace. In some examples, the communication channels represented can be associated with different workspaces (e.g., cross-workspace). In at least one example, if a communication channel is cross-workspace (e.g., associated with different workspaces), the user may be associated with both workspaces, or may only be associated with one of the workspaces. In some examples, the communication channels represented can be associated with combinations of communication channels associated with a single workspace and communication channels associated with different workspaces.

In some examples, the fourth sub-section 212 can depict all communication channels, or a subset of all communication channels, that the user has permission to access (e.g., as determined by the permission data). In such examples, the communication channels can be arranged alphabetically, based on most recent interaction, based on frequency of interactions, based on communication channel type (e.g., public, private, shared, cross-workspace, etc.), based on workspace, in user-designated sections, or the like. In some examples, the fourth sub-section 212 can depict all communication channels, or a subset of all communication channels, that the user is a member of, and the user can interact with the user interface 146 to browse or view other communication channels that the user is not a member of but are not currently displayed in the fourth sub-section 212. In some examples, different types of communication channels (e.g., public, private, shared, cross-workspace, etc.) can be in different sections of the fourth sub-section 212, or can have their own sub-regions or sub-panes in the user interface 146. In some examples, communication channels associated with different workspaces can be in different sections of the fourth sub-section 212, or can have their own regions or panes in the user interface 146.

In some examples, the indicators can be associated with graphical elements that visually differentiate types of communication channels. For example, a lock graphical element can indicate that the associated communication channel is private and access thereto is limited, whereas another communication channel may be public and access thereto is available to any member of an organization with which the user is associated. In some examples, graphical elements can be used to differentiate between shared communication channels, communication channels associated with different workspaces, communication channels with which the user is or is not a current member, and/or the like.

In at least one example, the second region 150 can include a fifth sub-section 214, or sub-pane, that can include indicators representative of communications with individual users or multiple specified users (e.g., instead of all, or a subset of, members of an organization). Such communications can be referred to as “direct messages.” That is, the fifth sub-section 214, or sub-pane, can include indicators representative of virtual spaces that are associated with private messages between one or more users.

Additionally, though not illustrated, the second region 150 can include a sub-section that is a personalized sub-section associated with a team of which the user is a member. That is, the “team” sub-section can include affordance(s) of one or more virtual spaces that are associated with the team, such as communication channels, collaborative documents, direct messaging instances, audio or video synchronous or asynchronous meetings, and/or the like. In at least one example, the user can associate selected virtual spaces with the team sub-section, such as by dragging and dropping, pinning, or otherwise associating selected virtual spaces with the team sub-section.

As described above, in at least one example, the user interface 146 can include a third region 152, or pane, that is associated with a feed indicating messages posted to and/or actions taken with respect to a virtual space (e.g., a virtual space associated with direct message communication(s), a virtual space associated with communication channel communication(s), a virtual space associated with collaborative document communication(s) (e.g., via a messaging or chat interface within a collaborative document), a virtual space associated with audio and/or video communications, etc.) for facilitating communications. As described above, in at least one example, data associated with the third region 152 can be associated with the same or different workspaces in which users are responding to resolve an incident. That is, in some examples, the third region 152 can present data associated with the same or different workspaces via an integrated feed. In some examples, the data can be organized and/or is sortable by time, type of action, virtual space, user, or the like. In some examples, such data can be associated with an indication of which user posted the message and/or performed an action. In examples where the third region 152 presents data associated with multiple workspaces or other virtual spaces, at least some data can be associated with an indication of which workspace or other virtual space the data is associated with.

For example, in FIG. 2, the user (e.g., User F), can interact with the user interface 146 to view data associated with the virtual space corresponding to “incidents.” In FIG. 2, data associated with the virtual space can be associated with the same incident. As illustrated, the data is organized by communication channel (e.g., #Channel-A). Though this is not intended to be so limiting, and the data can be organized and/or sortable by virtual space, time, type of action, user, and/or the like. As illustrated, other users (e.g., User Z and User C) are communicating with the communication channel, between and amongst one another. The user (e.g., User F) also posted a message (e.g., a user interface element, object, etc.), in the same communication channel. In some examples, the users may react to the message, represented by the indicator 216, with a like. As such, indicators associated with both messages can be presented in the third region 152. Because the data is organized by the virtual space, indicators associated with both messages are presented together.

For purposes of this discussion, a “message” can refer to any electronically generated digital object provided by a user using the user computing device 104 and that is configured for display within a communication channel and/or other virtual space for facilitating communications (e.g., a virtual space associated with direct message communication(s), etc.) as described herein. A message may include any text, image, video, audio, or combination thereof provided by a user (using a user computing device). For instance, the user may provide a message that includes text, as well as an image and a video, within the message as message contents. In such an example, the text, image, and video would comprise the message. Each message sent or posted to a communication channel of the communication platform can include metadata comprising a sending user identifier, a message identifier or indicator, message contents, a group identifier, a communication channel identifier or indicator, or the like. In at least one example, each of the foregoing identifiers may comprise American Standard Code for Information Interchange (ASCII) text, a pointer, a memory address, or the like.

In some examples, a user can comment on a message in a “thread.” A thread can be a message associated with another message that is not posted to a communication channel, but instead is maintained within an object associated with the original message. Messages and/or threads can be associated with file(s), emoji(s), app(s), etc.

A communication channel or other virtual space can be associated with data and/or content other than messages, or data and/or content that is associated with messages. For example, non-limiting examples of additional data that can be presented via the third region 152 of the user interface 146 include the summary documents 128, audio and/or video data associated with a conversation, members added to and/or removed from the communication channel, file(s) (e.g., file attachment(s)) uploaded and/or removed from the communication channel), application(s) added to and/or removed from the communication channel, post(s) (data that can be edited collaboratively, in near real-time by one or members of a communication channel) added to and/or removed from the communication channel, description added to, modified, and/or removed from the communication channel, modifications of properties of the communication channel, etc.

In some examples, the third region 152 can comprise a feed associated with a single virtual space. In such examples, data associated with the virtual space can be presented via the feed. In at least one example, data associated with a virtual space can be viewable to at least some of the users of a group of users associated with a same group identifier, such as users with appropriate permissions to access the virtual space. In some examples, for members of a virtual space, the content of the virtual space (e.g., messaging communications) can be displayed to each member of the virtual space. For instance, a common set of group-based messaging communications can be displayed to each member of the virtual space such that the content of the virtual space (e.g., messaging communications) may not vary per member of the virtual space. In some examples, data associated with a virtual space can appear differently for different users (e.g., based on personal configurations, group membership, etc.).

In at least one example, the format of the individual virtual spaces may appear differently to different users. In some examples, the format of the individual virtual spaces may appear differently based on which workspace a user is currently interacting with or most recently interacted with. In some examples, the format of the individual virtual spaces may appear differently for different users (e.g., based on personal configurations, group membership, etc.).

In at least one example, the user interface 146 can include a search mechanism 218, wherein a user can input a search term and the server(s) 102 can perform a search associated with the communication platform. In some examples, the search can be performed across each workspace with which the user is associated, or the search can be restricted to a particular workspace, based on a user specification.

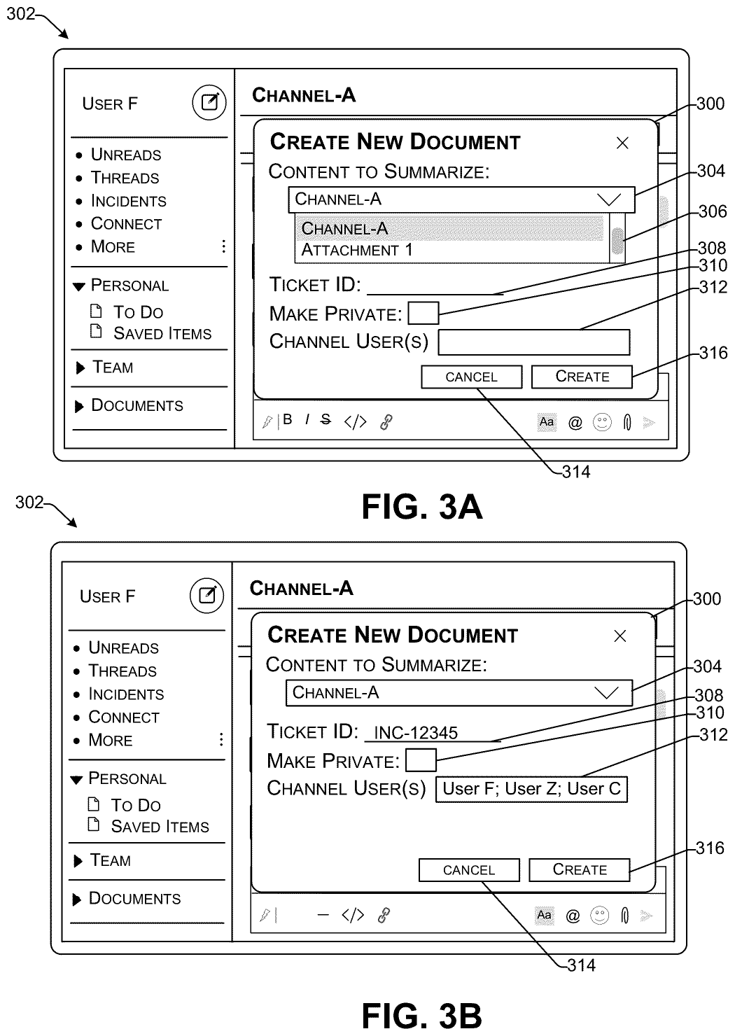

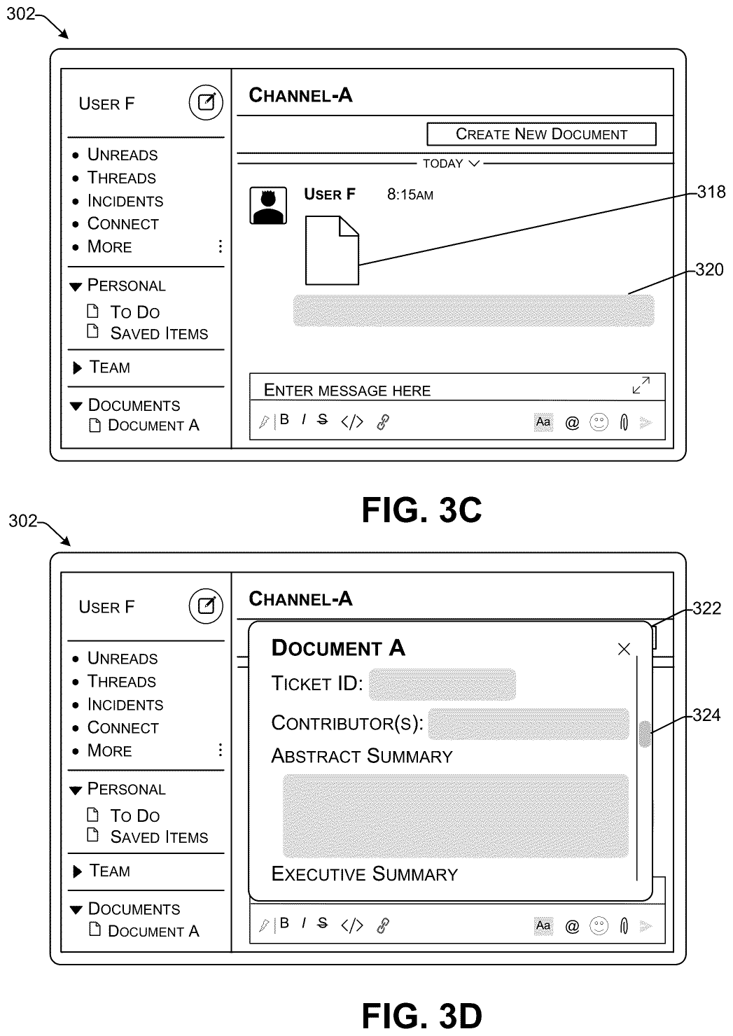

The user interface 146 may also include a create new document affordance 220. For example, to create a summary document 128 of the channel (Channel-A), the user may select the new document affordance 220. In response, and as will be discussed herein, the user interface 146 may display a dialogue window that allows the user to input specifics or criteria with which to create the summary document 128. In such examples, the summary document 128 can be associated with the communication channel. In some examples, the summarization component 120 can generate in response to receiving a request from a user to generate a new summary document. In some examples, the request can be received in association with a virtual space. In such examples, the summarization component 120 can associate the summary document 128 with the virtual space. For example, the collaborative document can be created in association with a communication channel, an audio-based synchronous or asynchronous meeting, a direct messaging instance, and/or the like. Details of the dialogue window are discussed herein with regard to FIGS. 3A-3D.

The user interface 146 includes a messaging box 222 that allows users within the channel to post to the virtual space. For example, users may type within the messaging box 222, upload images, documents, and so forth, react to posts, and so forth. In response to a message, the messaging component 116 may cause the virtual space to update and display the message. In some examples, the messaging component 116 can be configured to identify a mention or tag. In at least one example, the mention or tag can include an @mention (or other special character) of a user identifier that is associated with the communication platform. The user identifier can include a username, real name, or other unique identifier that is associated with a particular user. In response to identifying the mention or tag of the user identifier, the messaging component 116 can cause a notification to be presented on a user interface associated with the user identifier.

In some examples, the user may request generation of the summary document 128 by typing a command within the messaging box 222. For example, rather than selecting the create new document affordance 220, the commands may be used to summarize the communications within the communication channel. Here, the user may input various commands into the messaging box 222, to call a bot or API associated with generating the summary document 128. Example commands, include, for example: “/summarize #channel-A” to summarize the messages within the channel, “/summarize-abs<text>” to generate an abstract summary of the text inserted into the message box (i.e., between “<” and “>”, “/summarize-ext<text>” to generate an executive summary of the text inserted into the message box (i.e., between “<” and “>”, “/summarize #channel-A on Mar4” to summarize the messages within the channel on March 4th, or “/summarize document-A” to summarize a document posted to the channel and/or uploaded.

The user interface 146 is a non-limiting example of a user interface that can be presented via the user computing device 104 (e.g., by the application 142). In some examples, the application 142 can receive data from the messaging component 116, the audio/video component 118, and/or the summarization component 120 and the application 142 can generate and present the user interface 146 based on the data. In other examples, the application 142 can receive data from the messaging component 116 and/or the audio/video component 118, and instructions for generating the user interface 146 from the messaging component 116, the audio/video component 118, and/or the summarization component 120. In such an example, the application 142 can present the user interface 146 based on the instructions. Additional or alternative data can be presented via a user interface and additional or alternative configurations can be imagined.

FIGS. 3A-3D illustrates example user interfaces associated with a user requesting a summary document for a particular channel. For example, beginning with FIG. 3A, upon the user pressing the new document affordance 220 to create the summary document 128, a dialogue window 300 may be presented within a user interface 302 (similar to the user interface 146). For example, in response to receiving an input indicative of selecting the new document affordance 220 to create the summary document 128, the communication platform may cause the dialogue window 300 to be presented within the virtual space.

The dialogue window 300 includes several fields, information inputs, and the like associated with creating the summary document 128. For example, the dialogue window 300 may include a menu 304 that allows the user to select the communication channel(s), virtual space(s), workspace, document(s), and so forth with which to create the summary document 128. In some examples, the summary document 128 may be created for a single channel, a single virtual space, a single document, or multiple channels, multiple virtual spaces, and/or multiple documents. Still, in some examples, the summary document 128 may be created for any combination of channel(s), virtual space(s), and/or document(s).

As shown, the user may have the option to create the summary document 128 from “attachment 1.” Such attachment(s) (e.g., pdf, text, photo, etc.) may have been added or uploaded into the channel, for example, to discuss the incident. Additionally, or alternatively, the attachment may be a document that the user has stored on the user computing device 104, on a remote server, or other location. A scroll 306 allows the user to navigate through options within the menu 304.

A first field 308 is provided for the user to provide a ticket ID associated with the incident. For example, upon experiencing an issue, a user may request a ticket to be opened. This ticket may be associated with the ticket ID. Inputting the ticket ID into the first field may be used by the communication platform to glean additional information associated with the incident and when generating the summary document 128. For example, the ticket ID may be used to determine who reported the incident, a time associated with reporting the incident, the incident experienced by the user, and so forth.

A second field 310 is provided for the user to make the summary document 128 private. For example, checking the second field 310 as private may make the summary document 128 private to the user (i.e., the user requesting the summary document 128).

A third field 312 is provided for the user to input the names, identifiers, usernames, etc. of the members of the summary document 128. The user who is requesting the summary document 128 may input the names of these additional user via typing, selecting from a drop down menu, and so forth. In other examples, the users who are within the channel may be automatically added to the third field 312, for example, via the communication platform recognizing those users within the channel. The usernames entered within the third field 312 may be used to glean additional information about the users, such as their title, position, role, experience, etc.

A cancel affordance 314 is presented to allow the user to cancel requesting the summary document 128, while a create affordance 316 is presented to allow the user to request creation of the summary document 128.

While the dialogue window 300 illustrates certain fields, additional or alternative fields may be included. For example, the user may have an option to input time frames associated with the summary document, such as a start date and an ending date. Here, the user may specify Mar. 1, 2022, for example as the start date, and Mar. 4, 2022 as the end date. In response, the summary document 128 may be created for communications between these two dates. The user may also have the option to select times (e.g., 12:00 p.m.-3:00 p.m.) associated with creating the summary document. In some examples, the summary document 128 may be created for an entirety of the channel if the user does not specify the date/times for creating the summary document.

Additionally, or alternatively, the user may have the option to request the format of the summary document 128, such as whether to generate an abstractive summary and/or an executive summary.

In FIG. 3B, the dialogue window 300 is shown being populated with inputs on the user interface 302. For example, the user is shown to have selected the option to create the summary document 128 from “Channel-A” in menu 304. Additionally, the first field 308 includes the ticket ID associated with the incident, the second field 310 is not selected to make the summary document 128 private, and the third field 312 is shown including the users to associate with the summary document 128.

In FIG. 3C, following the selection of the create affordance 316, the summary document 128 may be created. For example, following a selection of the create affordance 316, the communication platform may cause the summary document 128 to be created. This may include the communication platform retrieving information to create the summary document 128, and/or the information being submitted to the communication platform.

Following a generation of the summary document 128, a document affordance 318 is shown being presented on the user interface 302, within the virtual space. For example, the document affordance 318 is shown being presented, where the users of the virtual space are communicating. In some examples, the document affordance 318 may be presented along with an indication 320 that represents a short description of the summary document 128. For example, the indication 320 may include a short title of the summary document 128, a file size of the summary document 128, a length of the summary document 128, an identifier of who requested the summary document 128, and so forth.

The users within the virtual space may select the document affordance 318 to open the summary document 128. In some examples, the summary document 128 may be downloaded following a selection of the document affordance 318. Moreover, the summary document 128 may be included within the documents tab on the first region 148 of the user interface 302.

Following a selection of the document affordance 318, for example, the summary document 128 may be presented. For example, in FIG. 3D, a window 322 is shown that allows the user to view the summary document 128. In some examples, the summary document 128 (or more generally, the pop-up window 322) may be presented over the first region 148, the second region 150, and/or the third region 152. In other examples, the summary document 128 may be displayed in a sidebar.

The summary document 128 is shown including the ticket ID, contributor(s) that are associated with the user(s) in the channel, an abstract summary (e.g., short summary), and/or an executive summary (e.g., long summary). A scroll 324 allows the user to scroll through the summary document 128 to view additional information associated with the summary document 128. As discussed above, the summary document 128 may be generated based on interactions of the users within the virtual space, a frequency of access by the users, a frequency of interaction by other users, a title and/or role of the users, and so forth. Other information may be included within the summary document 128, such as, for example, tasks performed by the users, future tasks assigned to the users, an amount of messages summarized, a time to resolve the incident, and the like.

The summary document may also include a summary from multiple virtual spaces. For example, the summary document may include a first summary for a first virtual space and a second summary, separate from the first summary, for a second virtual space. Such summaries may be provided in a single summary document to allow the user to get summaries of multiple virtual spaces in a single document. However, in some examples, a single summary may be created across multiple virtual spaces.

Although FIGS. 3A-3D illustrate a certain scenario by which to request generation of the summary document 128, other requests or forms of input are envisioned. For example, rather than inputting a command or selecting an affordance within the UI, users may audibly issue a request to generate the summary document 128. As another example, upon resolving of the incident or closing of the virtual space, the summary document 128 may be automatically generated. Yet still, the summary document 128 may be generated based on predetermined timeframes (e.g., daily) and/or according to schedules of the user (e.g., return from work).

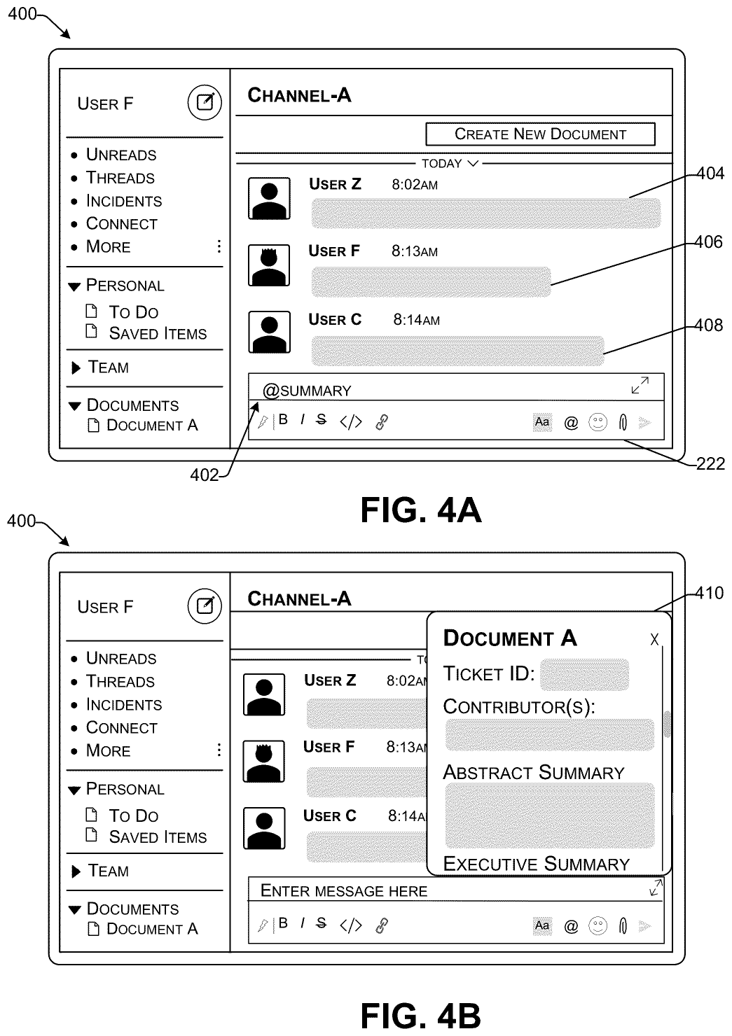

FIGS. 4A and 4B illustrates example user interfaces associated with a user requesting a summary document for a particular channel. For example, beginning with FIG. 4A, a user interface 400 is shown displaying messages associated with a communication channel. In some examples, the user may type a message into the messaging box 222 to generate the summary document 128 of the communication channel. In some examples, typing “@summary” or another command 402 into the messaging box 222 may summarize communications within the communication channel, such as a first message 404 from a first user, a second message 406 from a second user, and a third message 408 from a third user. The command 402, for example, may call an API, a bot, or other program of the communication platform to generate the summary document.

In response to entering the command 402, and submitting the command 402 (e.g., pressing submit, send, enter, etc.), the summary document 128 may be presented within the user interface 400. In some examples, the summary document 128 may be presented within a pop-up window or sidebar 410. Here, the user may scroll through the summary document 128. Although a particular visualization of the summary document 128 is shown, other visualizations are contemplated. For example, the sidebar 410 may take up more or less of the user interface 410 as shown. As such, calling the command 402 may post the summary document 128 automatically in the communication channel, open the summary document 128 in another pane, open the summary document 128 as a separate document, and so forth. Still, in some examples, the summary document 128 may be posted in another channel and/or may notify users that the summary document 128 has been generated (e.g., via the usernames being included in the summary document 128).

Although the summary document 128 is shown including certain fields or text, other content is envisioned. For example, the summary document 128 may include tasks that are to be performed. The tasks maybe associated with resolving the incident, responding to the incident, or preventing future incidents. In some examples, the tasks may be associated with respective users and/or when the users are to perform the tasks. The tasks may be include past tasks that were performed by the users, and when those tasks were performed for resolving the incident.

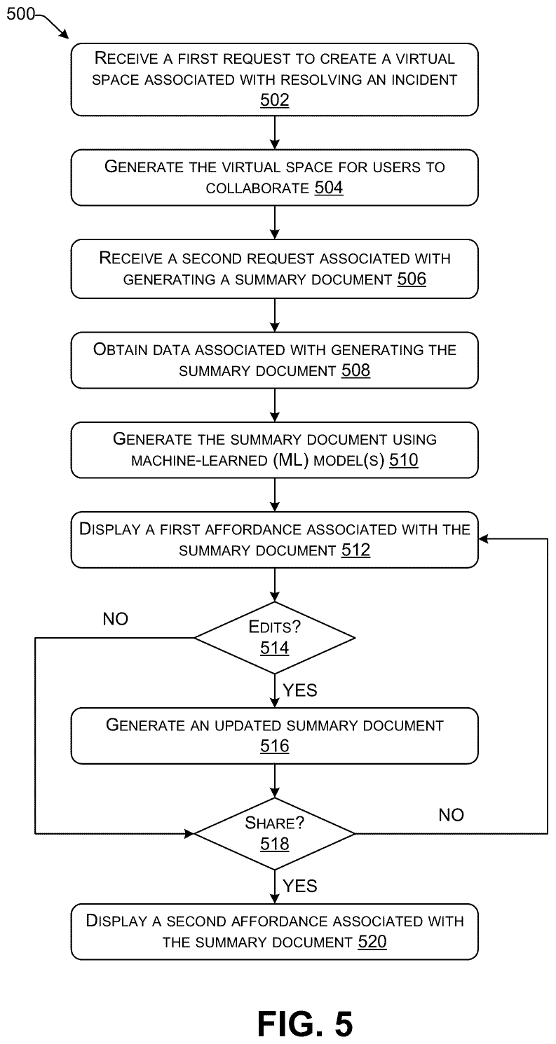

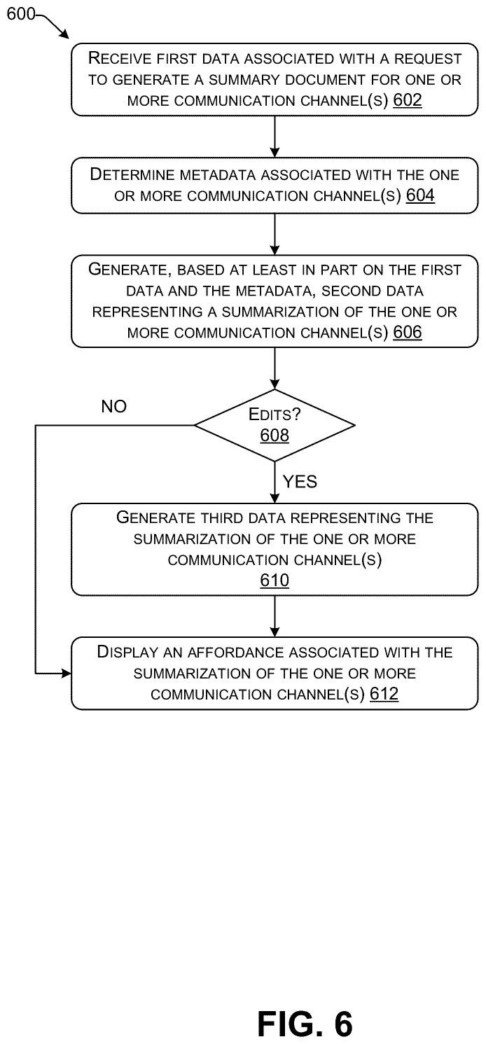

FIGS. 5 and 6 illustrate various processes related to generating summary documents. The processes described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-4B, although the processes may be implemented in a wide variety of other environments, architectures and systems.

FIG. 5 illustrates an example process 500 associated with generating a summary document for a virtual space.

In some examples, the process 500 at 502 may include receiving a first request to create a virtual space associated with resolving an incident. For example, a user may be experiencing a bug that causes some unexpected result to occur. This bug may be associated with the communication platform hosting the virtual space, or may be separate from the communication platform. Regardless, in an effort to resolve the bug, the user may create the virtual space and within the virtual space, users may interact, communicate, or otherwise engage to solve the incident. Within the virtual space, the users may exchange messages, upload content (e.g., images, videos, etc.), upload documents (e.g., text, pdfs, etc.), and the like. In some examples, the users may collaborate to solve the incident, or determine the root cause of the document, by communicating within the virtual space. Any number of users may be included within the virtual space and in some examples, the users may be invited into the virtual space.

At 504, the process 500 may include generating the virtual space. For example, the communication platform may generate the virtual space for the users to collaborate within. In some examples, the communication platform may invite users into the virtual space, or an administrator (e.g., creator) of the virtual space may invite users into the virtual space.

At 506, the process 500 may include receiving a second request associated with generating a summary document. For example, upon completion of resolving the incident, the communication platform may process the second request and generate the summary document 128. In some examples, the summarization component 120 may utilize ML model(s) 126 when generating the summary document 128. The second request may be received in response to a user of the virtual space selecting an affordance within the user interface to generate the summary document 128. For example, one of the users of the virtual space may select the affordance and in response, the request to generate the summary document 128 may be received. The second request may also specify a context about the type of the summary document 128, such as whether the summary document 128 is to be created from a portion of the communication channel, an entirety of the communication channel, a certain date and/or time, changes since a previous summary document 128 was generated, and so forth. The second request may also specify whether the summary document 128 is to be a private document, is a public document, permissions of the summary document, as determined based on channel permissions, user permissions, etc. However, in other examples, the second request to generate the summary document 128 may not be received expressly from the user, but may be received automatically in response to certain events, such as a lapsing of a time period (e.g., making a summary every day, week, month, return from office after a vacation), an amount of messages in the communication channel being above a threshold, etc.

At 508, the process 500 may include obtaining data associated with generating the summary document. In some examples, the second request may specify the content to be used when creating the summary document 128, and after receiving the second request, the summarization component 120 may obtain the content to generate the summary document 128. In some examples, the content may be obtained from the virtual space, such as messages exchanged back and forth within the virtual space and between users, content (e.g., videos, audio, images, etc.) uploaded into the virtual space, reactions to certain content (e.g., likes, responses, etc.), links uploaded to the virtual space, and so forth. In other examples, the second request may specify a file location of documents that are to be summarized. For example, the second request may specify a file location to be summarized, and in response, the summarization component 120 may upload (or otherwise fetch) the document. In some examples, the summarization component 120 may summarize any number of documents and/or content within the virtual space into a single, common, summary document 128.

At 510, the process 500 may include generating the summary document using machine-learned (ML) model(s). For example, the summarization component 120 may utilize the ML model(s) 126 to summarize the content within the virtual space and/or the documents. The (ML) model(s) 126 may accept inputs, such as conversation data from the virtual space that includes text messages, emojis, user identifiers, photos, user actions (e.g., “likes” or “dislikes”), charts, videos, and/or other forms of content. The inputs may also include text data, documents, images, video(s), or other forms of content that the summarization component 120 is to summarize.

As it relates to resolving the incident, the ML model(s) 126 are tasked with summarizing the incident and generating the summary document 128 that represents a RCA of the incident. As part of resolving the incident, the users may interact about causes of the incident, symptoms of the incident, and the like by messaging one another and posting content (e.g., audio, video, links, etc.) to the virtual space, and so forth. For example, different users may have different hypotheses about the root cause of the incident, share those within the virtual space, disprove or prove the hypothesis, and so forth. All of these communications may be recorded in the virtual space, but the ML model(s) 126 may determine the results of the RCA. For example, the ML model(s) 126 may generate a summary document that identifies the hypothesis of the first user, the hypothesis of the second user, as well as the determined root cause for the incident. Upon reviewing the summary document 128, users may quickly understand the topics discussed and the conclusions reached.

The ML model(s) 126 may be trained to summarize the communications within the virtual space. For example, the ML model(s) 126 may distill important parts of a conversation within the virtual space based on contextual cues, a frequency of communications by the user(s), communications (or other interactions of the users) exceeding a threshold level, communications of the user being marked as a favorite, an assignment of tasks to users, a rating of the users, an expertise of the user, user preferences implied on their respective roles, user specified parameters, user specified permissions, heuristics from user activities, and/or other interactions of the users with previously generated summary documents. Additionally, the ML model(s) 126 may be trained to identify one or more users to be associated with the summary document 128, such as those users that were mentioned in the virtual space, posted to the virtual space, or are members of the virtual space. The ML model(s) 126 may also be trained to identify the respective messages, contributions, posts, and the like for the user(s) within the virtual space.

At 512, the process 500 may include displaying a first affordance associated with the summary document 128. For example, the first affordance may be presented on an user interface. The first affordance may be presented within a sidebar of the virtual space and/or may be presented within the virtual space. Clicking on the first affordance may cause the summary document to be presented.

At 514, the process 500 may include determining whether any edits are received associated with editing the summary document. For example, the other users of virtual space, at this instance, may not be able to view the summary document. Instead, the summary document 128 may only be presented to user that requested the summary document 128 In other examples, the summary document 128 may first be presented to the user who requested the summary document 128 to permit the user the opportunity to edit the summary document before being shared with the other users within the virtual space, or users external to the virtual space. For example, the user who requested the summary document 128 may reorganize content within the summary document 128 (e.g., textual, visual, etc.), correct informalities within the summary document 128 (e.g., spelling, punctuation, format, etc.), add content (e.g., textual, visual, etc.) to the within the summary document 128, delete content within the summary document 128, and so forth. In some examples, these changes may be tracked within the summary document 128 such that additional users are able to see the changes made by the user.

As such, the summary document 128 supports editable text and/or objects that can be ordered, added, deleted, modified and/or the like. In some examples, an object can include, but is not limited to, text (e.g., which can be editable), a file (e.g., text, audio, video, an application, etc.), a task to be completed, a ticket to be resolved, an event (e.g., scheduled event, calendar invitation, calendar instance, etc.), a message previously transmitted via the communication platform, an image, a graphic, a link to a local object, a link to a remote object (e.g., third-party object), and/or the like. In this manner, the communication platform can treat the summary document as a synopsis or outline of the virtual space and the posts, events, etc. that took place within the virtual channel. As such, functionalities of the virtual space may be imbued in the summary document.

If at 514 the process 500 may include determining whether any edits were received, the process 500 may follow the “YES” route and proceed to 516. At 516, the process 500 may include generating and updated summary document. For example, based on the edits applied by the user, the summarization component 120 may generate a new, updated summary document 128. Following the generation of the new summary document 128, at 518, the process 500 may include determining whether an indication is received associated with sharing the updated summary document 128. For example, the user who requested the summary document 128 may provide an indication as to whether to share the summary document with the virtual space. Sharing the summary document 128 within the virtual space makes the summary document 128 available for viewing and editing by the other users in the virtual space. The process 500 may also proceed to 518 following the “NO” route from 514 and when no edits are received to the summary document 128.

At 520, the process 500 may include determining whether an indication is received associated with sharing the updated summary document. For example, following a generation of the updated summary document, the user who requested the summary document may determine whether or not to share the summary document with other users, whether within or external to the virtual space. If the user chooses to not share the updated summary document, the process 500 may follow the “NO” route and proceed to 512, whereby the updated summary document may be displayed to the user (e.g., privately).

Alternatively, if at 520 the process 500 determines that the indication is received associated with sharing the updated document, the process 500 may follow the “YES” route and proceed to 522. At 522, the process 500 may include displaying a second affordance associated with the summary document 128. For example, the second affordance may be presented on the user interface. In some examples, the second affordance may replace the first affordance previously presented to the user, and additionally, may be presented within the virtual space to access by the other users. Clicking on the second affordance may cause the summary document to be presented.

FIG. 6 illustrates an example process 600 associated with receiving a request to generate a summary document 128 and generating a summary document 128 in response to the request.

At 602, the process 600 may include receiving first data associated with a request to generate a summary document for one or more communication channel(s). For example, a user may submit a request to generate a summary document 128 for one or more communication channel(s). In some examples, the request indicates the communication channel(s) with which to generate the summary document and the communication platform may use the communication channel(s) to generate the summary document. For example, the request may specify channel identifier(s) (e.g., channel IDs) or channel indicator(s) of the one or more communication channel(s). Although described as generating a summary document for one or more communication channel(s), the request may additionally or alternatively be associated with generating the summary document for document(s) (e.g., document(s) uploaded into the communication channel(s), document(s) locally saved on the user computing devices 104, document(s) remotely saved, and so forth). In such instances, the request may specify the file location of the document(s), and such document(s) may be received by the communication platform.

At 604, the process 600 may include determining metadata associated with the one or more communication channel(s). In some examples, the metadata may include determining the user(s) of the one or more communication channel(s). For example, by determining, accessing, or obtaining data associated with the one or more communication channel(s), the communication platform may access the messages within the communication channel(s) for determining the user(s) that were involved in the communication channel(s), respectively. This allows the communication platform to consider a context of the message(s) and which user(s) posted within the communication channel(s).

At 606, the process 600 may include generating, based at least in part on the first data and the metadata, second data representing a summarization of the one or more communication channel(s). The summarization component 120, or more specifically, the ML model(s) 126 may receive messages from the communication platform for generating the summarization. Here, the summarization may represent a RCA document to the incident. The messages, in some examples, may be from the virtual space for a given time period. In some examples, the messages may be raw messages posted to the communication platform by different users. In such instances, the ML model(s) 126 may disentangle messages to determine communications of respective users within the virtual space.

For example, the messages may be from different users within the virtual space, where a first message may have originated from a first user and a second message may have originated from a second user. Both messages, for example, may be via a user interfaces presented to the users, respectively. For example, the messages may be from a real-time conversation in the virtual space. In some examples, the messages may belong to the same virtual space based on an indicator of the virtual space. For example, metadata associated with the messages, such as a virtual space ID, a source ID, and/or the like may be used to associate the messages with the virtual space.

The summarization component 120, using the ML model(s) 126, may generate the summary document. For example, a thread of messages (e.g., text) may form an input sequence for the ML model(s) 126, which may be a neural model trained as an abstractive or a generative summarization model. The summary document 128 represents a summary of the messages for the virtual space. In some examples, the ML model(s) 126 are trained with historical communications contained within virtual spaces. The summary document 128 may include a timestamp. For example, the timestamp may indicate the summary of the virtual space is based on messages of a certain date, a certain time period, and/or the like.

In some examples, the ML model(s) 126 may generate the summarization based on certain keywords that describe the incident. For example, in some examples, the request may include keyword(s) associated with the incident, and the ML model(s) 126 may utilize these keyword(s) when parsing through the communication channel(s) and generating the summarization. Here, the ML model(s) 126 may identify instances of the keyword(s) within the communication channel(s) and use these keyword(s) as a way to summarize the communication channel(s). In other examples, the ML model(s) 126 may accept, as an input, a description of the incident and the ML model(s) 126 may then generate the summarization based on this description.

In some examples, the summarization may be generated from a template that is stored by the communication platform. The template, for example, may be modified (e.g., filled in, updated, completed, etc.) based on the entries within the request. In some examples, the communication platform may store multiple template(s), and a respective template may be selected based on the request. For example, depending upon the type of incident associated with the request, a template may be selected. The types of incidents, for example, may include marketing incidents, service incidents, sales incidents, and so forth. In some examples, the templates may include a different number of editable fields, entries, and so forth.

In some examples, the summarization component 120 may generate different versions of summaries according to personal preferences of users. For example, the user preference may be specified by each user by configuring their own preference parameters, or may be determined based on user feedback, or the role of the user in a chat group. Additionally, or alternatively, the user requesting the summary document may specify permission settings, such as whether the summary document is read or view-only setting, full editing permissions, and/or the like. The summarization may be generated with the preferences and the permissions.

At 608, the process 600 may include determining whether any edits are received associated with editing the summarization. For example, the user who requested the summary document 128 may reorganize content within the summary document 128 (e.g., textual, visual, etc.), correct informalities within the summary document 128 (e.g., spelling, punctuation, format, etc.), add content (e.g., textual, visual, etc.) to the within the summary document 128, delete content within the summary document 128, and so forth. In some examples, these changes may be tracked within the summary document 128 such that additional users are able to see the changes made by the user. If at 608 the process 600 determines that edits were received, the process 600 may follow the “YES” route and proceed to 610.

At 610, the process 600 may include generating third data representing the summary of the one or more communication channel(s). For example, based on the edits applied by the user, the summarization component 120 may generate a new, updated summary document 128. Following the generation of the new summary document 128, at 612, the process 600 may include displaying an affordance associated with the summarization of the one or more communication channel(s). For example, the affordance may be presented on an user interface. The affordance may be presented within a sidebar of the virtual space and/or may be presented within the virtual space. Clicking on the affordance may cause the summary document to be presented. The process 600 may also proceed to 612 following the “NO” route from 608.

As such, the techniques described herein may receive inputs (e.g., a job ticket and possible usernames as) and output a RCA document detailing all the information about the incident. However, although described herein as generating a summary document that includes a RCA for an incident, the techniques described herein may use the ML model(s) 126 to receive other inputs and, in response, output other documents. As such, the ML model(s) 126 may generate summaries of any input set of data and generate an output document that may be provided to the users of the virtual space.

### Example Clauses

A: A method, implemented at least in part by one or more computing devices of a communication platform, the method comprising: receiving a first message originating from a first user and a second message originating from a second user; determining that the first message and the second message belong to a communication channel of the communication platform based at least in part on a channel indicator associated with the first message and the second message; determining an occurrence of an event associated with the communication platform; providing, based at least in part on the occurrence of the event, the first message, the second message, and context data as an input to a machine-learned summarization model; generating, by the machine-learned summarization model and based at least in part on the input, a document that represents a summary of at least a portion of the communication channel; and causing display of an affordance representing the document.

B: The method of paragraph A, wherein the affordance is displayed as at least one of: an attachment within the communication channel; a link associated with a message; or an image.

C: The method of paragraph A or B, wherein the event comprises at least one of: a request to generate the document; a threshold period of time elapsing; or a number of messages within the communication channel being greater than a threshold number.

D: The method of any of paragraphs A-C, further comprising: receiving an indication of an incident experienced by one or more users; and generating the communication channel based at least in part on receiving in indication.

E: The method of any of paragraphs A-D, further comprising: receiving at least one edit to the document; generating, based at least in part on the at least one edit, a second document that represents the summary of the communication channel; and generating a second affordance representing the summary.

F: The method of any of paragraphs A-E, further comprising receiving a second document uploaded or posted into the communication channel, and wherein: the second document is provided as an input to the machine-learned summarization model; and the document further represents a summary of the second document.

G: The method of any of paragraphs A-F, wherein generating the summary of the communication channel is based on the input according to one or more preferences of at least one of the first user or the second user.

H: The method of any of paragraphs A-G, wherein the one or more preferences include at least one of: permissions associated with the document; editing abilities of the document; or a publicity of the document.

I: The method of any of paragraphs A-H, further comprising determining at least one of a first identity of the first user or a second identity of the second user, and wherein the document is based at least in part on the at least one of the first identity or the second identity.

J: The method of any of paragraphs A-I, wherein causing display of the affordance includes at least one of: causing the affordance to be displayed within a user interface of the communication channel; causing the affordance to be displayed within a separate pane as the user interface; or causing the affordance to be displayed within a sidebar to the user interface.

K: The method of any of paragraphs A-J, wherein the document includes one or more tasks assigned to at least one of the first user or the second user.

L: A system comprising: one or more processors; and one or more non-transitory computer-readable media storing instructions that, when executed, cause the system to perform operations comprising: receiving a first message originating from a first user and a second message originating from a second user; determining that the first message and the second message belong to a communication channel of the communication platform based at least in part on a channel indicator associated with the first message and the second message; determining an occurrence of an event associated with the communication platform; providing, based at least in part on the occurrence of the event, the first message, the second message, and context data as an input to a machine-learned summarization model; generating, by the machine-learned summarization model and based at least in part on the input, a document that represents a summary of at least a portion of the communication channel; and causing display of an affordance representing the document.

M: The system of paragraph L, wherein the event comprises at least one of: a request to generate the document; a threshold period of time elapsing; or a number of messages within the communication channel being greater than a threshold number.

N: The system of paragraph L or M, the operations further comprising: receiving at least one edit to the document; generating, based at least in part on the at least one edit, a second document that represents the summary of the communication channel; and generating a second affordance representing the summary.

O: The system of any of paragraphs L-N, wherein causing display of the affordance includes at least one of: causing the affordance to be displayed within a user interface of the communication channel; causing the affordance to be displayed within a separate pane as the user interface; or causing the affordance to be displayed within a sidebar to the user interface.

P: The system of any of paragraphs L-O, further comprising determining at least one of a first identity of the first user or a second identity of the second user, and wherein the document is based at least in part on the at least one of the first identity or the second identity.

Q: One or more non-transitory computer-readable media storing instructions that, when executed by one or more processors, cause the one or more processors to perform operations comprising: receiving a first message originating from a first user and a second message originating from a second user; determining that the first message and the second message belong to a communication channel of the communication platform based at least in part on a channel indicator associated with the first message and the second message; determining an occurrence of an event associated with the communication platform; providing, based at least in part on the occurrence of the event, the first message, the second message, and context data as an input to a machine-learned summarization model; generating, by the machine-learned summarization model and based at least in part on the input, a document that represents a summary of at least a portion of the communication channel; and causing display of an affordance representing the document.

R: The one or more non-transitory computer-readable media of paragraph Q, wherein causing display of the affordance includes at least one of: causing the affordance to be displayed within a user interface of the communication channel; causing the affordance to be displayed within a separate pane as the user interface; or causing the affordance to be displayed within a sidebar to the user interface.

S: The one or more non-transitory computer-readable media of any of paragraphs Q or R, the operations further comprising: receiving at least one edit to the document; generating, based at least in part on the at least one edit, a second document that represents the summary of the communication channel; and generating a second affordance representing the summary.

T: The one or more non-transitory computer-readable media of any of paragraphs Q-S, wherein the document includes one or more tasks assigned to at least one of the first user or the second user.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

1. A method, implemented at least in part by one or more computing devices of a communication platform, the method comprising:
receiving, via a virtual space of a plurality of virtual spaces of the communication platform, a first message from a first user of the communication platform and a second message from a second user of the communication platform;
determining that the first message and the second message are associated with a virtual space identifier, wherein the virtual space identifier is associated with the virtual space of the communication platform;
receiving, from at least one of the first user or the second user, a request to generate a summary document associated with at least one virtual space of the plurality of virtual spaces, wherein the summary document represents at least a portion of the at least one virtual space of the plurality of virtual spaces;
causing presentation, via the virtual space, of one or more options associated with selecting one or more virtual spaces of the plurality of virtual spaces to associate with the summary document;
based at least in part on receiving a selection of the virtual space of the plurality of virtual spaces to associate with the summary document, inputting, into a machine-learned summarization model and based at least in part on receiving the request to generate the summary document, the first message, the second message, and the virtual space identifier;
generating, by the machine-learned summarization model, the summary document; and
causing presentation, via the virtual space of the communication platform, of the summary document.

2. (canceled)

3. The method of claim 1, further comprising:
receiving an indication of an event associated with the communication platform,
wherein inputting the first message, the second message, and the virtual space identifier is based at least in part on receiving the indication of the event.

4. The method of claim 1, further comprising:
receiving an indication of an incident experienced by at least one of the first user of the communication platform or the second user of the communication platform; and
generating, based at least in part on receiving the indication of the incident, the virtual space of the communication platform.

5. The method of claim 1, wherein the summary document is a first summary document, the method further comprising:
receiving, from at least the first user of the communication platform or the second user of the communication platform, one or more edits to the first summary document;
generating, based at least in part on receiving the one or more edits to the first summary document, a second summary document, wherein the second summary document includes the one or more edits to the first summary document; and
causing presentation, via the virtual space of the communication platform, of the second summary document.

6. The method of claim 5, further comprising:
receiving, via the virtual space of the communication platform, a document; and
inputting, the document into to the machine-learned summarization model;
wherein the second summary document includes the document.

7. The method of claim 1, wherein generating the summary document is based at least in part on one or more preferences of at least one of the first user of the communication platform or the second user of the communication platform.

8. The method of claim 7, wherein the one or more preferences include at least one of:
a permission associated with the summary document;
an editing ability of the summary document; or
a publicity of the summary document.

9. The method of claim 1, further comprising:
determining at least one of a first identity of the first user associated with the communication platform or a second identity associated with the second user of the communication platform;
wherein the summary document is based at least in part on the at least one of the first identity or the second identity.

10. The method of claim 1, wherein causing presentation of the summary document includes at least one of:
causing an indication of the summary document to be displayed within a user interface of the virtual space;
causing an indication of the summary document to be displayed within a separate pane as the user interface; or
causing an indication of the summary document to be displayed within a sidebar to the user interface.

11. The method of claim 1, wherein the summary document includes one or more tasks assigned to at least one of the first user of the communication platform or the second user of the communication platform.

12. A system comprising:
one or more processors; and
one or more non-transitory computer-readable media storing instructions that, when executed, cause the system to perform operations comprising:
receiving, via a virtual space of a plurality of virtual spaces of a communication platform, a first message from a first user of the communication platform and a second message from a second user of the communication platform;
determining that the first message and the second message are associated with a virtual space identifier, wherein the virtual space identifier is associated with the virtual space of the communication platform;
receiving, from at least one of the first user or the second user, a request to generate a summary document associated with at least one virtual space of the plurality of virtual spaces, wherein the summary document represents at least a portion of the at least one virtual space of the plurality of virtual spaces;
causing presentation, via the virtual space, of one or more options associated with selecting one or more virtual spaces of the plurality of virtual spaces to associate with the summary document;
based at least in part on receiving a selection of the virtual space of the plurality of virtual spaces to associate with the summary document, inputting, into a machine-learned summarization model and based at least in part on receiving the request to generate the summary document, the first message, the second message, and the virtual space identifier;
generating, by the machine-learned summarization model, the summary document; and
causing presentation, via the virtual space of the communication platform, of the summary document.

13. The system of claim 12, further comprising:
receiving an indication of an event associated with the communication platform,
wherein inputting the first message, the second message, and the virtual space identifier is based at least in part on receiving the indication of the event.

14. The system of claim 12, wherein the summary document is a first summary document, the operations further comprising:
receiving, from at least the first user of the communication platform or the second user of the communication platform, one or more edits to the first summary document;
generating, based at least in part on receiving the one or more edits to the first summary document, a second summary document, wherein the second summary document includes the one or more edits to the first summary document; and
causing presentation, via the virtual space of the communication platform, of the second summary document.

15. The system of claim 12, wherein causing presentation of the summary document includes at least one of:
causing an indication of the summary document to be displayed within a user interface of the virtual space;
causing an indication of the summary document to be displayed within a separate pane as the user interface; or
causing an indication of the summary document to be displayed within a sidebar to the user interface.

16. The system of claim 12, further comprising:
determining at least one of a first identity associated with the first user of the communication platform or a second identity associated with the second user of the communication platform;
wherein the summary document is based at least in part on the at least one of the first identity or the second identity.

17. One or more non-transitory computer-readable media storing instructions that, when executed by one or more processors, cause the one or more processors to perform operations comprising:
receiving, via a virtual space of plurality of virtual spaces of a communication platform, a first message from a first user of the communication platform and a second message from a second user of the communication platform;
determining that the first message and the second message are associated with a virtual space identifier, wherein the virtual space identifier is associated with the virtual space of the communication platform;
receiving, from at least one of the first user or the second user, a request to generate a summary document associated with at least one virtual space of the plurality of virtual spaces, wherein the summary document represents at least a portion of the at least one virtual space of the plurality of virtual spaces;
causing presentation, via the virtual space, of one or more options associated with selecting one or more virtual spaces of the plurality of virtual spaces to associate with the summary document;
based at least in part on receiving a selection of the virtual space of the plurality of virtual spaces to associate with the summary document, inputting, into a machine-learned summarization model and based at least in part on receiving the request to generate the summary document, the first message, the second message, and the virtual space identifier;
generating, by the machine-learned summarization model, the summary document; and
causing presentation, via the virtual space of the communication platform, of the summary document.

18. The one or more non-transitory computer-readable media of claim 17, wherein causing presentation of the summary document includes at least one of:
causing an indication of the summary document to be displayed within a user interface of the virtual space;
causing an indication of the summary document to be displayed within a separate pane as the user interface; or
causing an indication of the summary document to be displayed within a sidebar to the user interface.

19. The one or more non-transitory computer-readable media of claim 17, wherein the summary document is a first summary document, the operations further comprising:
receiving, from at least the first user of the communication platform or the second user of the communication platform, one or more edits to the first summary document;
generating, based at least in part on receiving the one or more edits to the first summary document, a second summary document, wherein the second summary document includes the one or more edits to the first summary document; and
causing presentation, via the virtual space of the communication platform, of the second summary document.

20. The one or more non-transitory computer-readable media of claim 17, wherein the summary document includes one or more tasks assigned to at least one of the first user of the communication platform or the second user of the communication platform.

21. The method of claim 3, wherein the event comprises at least one of:
a determination of an occurrence of a bug;
a threshold period of time elapsing; or
a number of messages within the virtual space being greater than or equal to a threshold number.
